(19) United States
(12) Patent Application Publication
(10) Pub. No.: US 2025/0322086 A1
(43) Pub. Date: Oct. 16, 2025

(54) SYSTEM, METHOD, AND APPARATUS FOR MEDICAL SYSTEM GOVERNANCE

(71) Applicant: Ethicon Endo-Surgery, Inc, Cincinnati, OH (US)

(72) Inventors: Subramanian Chidambaram, Bangalore (IN); Yevgeniy Sanin, Castro Valley, CA (US); LeRoy Ruggerio, Easton, PA (US); Sheri Arnell, Silver Spring, MD (US)

(21) Appl. No.: 18/634,461

(22) Filed: Apr. 12, 2024

(51) Int. Cl. G06F 21/62

(52) U.S. Cl. CPC G06F 21/62

(57) ABSTRACT

A medical system governance platform is configured to determine an occurrence of a trigger event, wherein the trigger event initiates a governance check to be performed on data associated with the trigger event, obtain, as part of the governance check, governance metadata corresponding to the data associated with the trigger event, wherein the governance metadata is associated with at least one rule base for the data associated with the trigger event, obtain, as part of the governance check, a governance parameter based on at least one of the governance metadata, a parameter associated with the trigger event, and the at least one rule base, wherein the governance parameter is indicative of a governance action related to the data associated with the trigger event, and initiate performance of a governance action based on an evaluation of the governance parameter.

### TECHNICAL FIELD

The disclosure herein is directed to systems and methods for automating computer information system governance, and more particularly to automating medical system governance based on rules, guidelines, and various parameters.

### BACKGROUND

Cloud-based systems may offer scalable, flexible, and cost-effective processing solutions for various purposes. Cloud-based systems may include public, private, and hybrid public-private cloud systems, which may provide infrastructure as a service (IaaS), platforms as a service (PaaS), and software suites as a service (SaaS) to users. Cloud-based systems may include cloud-based repositories, which may be local, remote, or a combination thereof. In some cases, cloud systems may provide functionality to manage compute resources associated with the cloud system. However, the management of compute resources is often focused on operational issues such as one or more of availability, performance, adding and tearing down nodes, load-balancing, cost, etc.

### SUMMARY

A processor-implemented method on a medical system governance platform (MGP) is disclosed. The processor-implemented method comprises determining an occurrence of a trigger event, in which the trigger event initiates a governance check to be performed on data associated with the trigger event. The processor-implemented method further comprises obtaining, as part of the governance check, governance metadata corresponding to the data associated with the trigger event, in which the governance metadata is associated with at least one rule base for the data associated with the trigger event, and the at least one rule base comprises one or more conditions for at least one of usage, transfer, storage, retention, deletion, or archival of the data. The processor-implemented method further comprises determining, as part of the governance check, a governance parameter based on at least one of the governance metadata, at least one event parameter associated with the trigger event, and the at least one rule base, in which the governance parameter is indicative of a governance action related to the data associated with the trigger event, and initiating performance of a governance action based on an evaluation of the governance parameter.

A medical system governance platform (MGP) is disclosed. The MGP comprises a memory configured to store instructions, and a processor coupled to the memory and configured to execute the instructions, which cause the processor to be configured to determine an occurrence of a trigger event, in which the trigger event initiates a governance check to be performed on data associated with the trigger event, obtain, as part of the governance check, governance metadata corresponding to the data associated with the trigger event, in which the governance metadata is associated with at least one rule base for the data associated with the trigger event, and the at least one rule base comprises one or more conditions for at least one of usage, transfer, storage, retention, deletion, or archival of the data, determine, as part of the governance check, a governance parameter based on at least one of the governance metadata, at least one event parameter associated with the trigger event, and the at least one rule base, in which the governance parameter is indicative of a governance action related to the data associated with the trigger event, and initiate performance of a governance action based on an evaluation of the governance parameter.

A non-transitory computer readable medium is disclosed. The non-transitory computer readable medium comprises computer executable instructions stored on the non-transitory computer readable medium that, when executed by a processor in a medical system governance platform (MGP), cause the processor to be configured to determine an occurrence of a trigger event, in which the trigger event initiates a governance check to be performed on data associated with the trigger event, obtain, as part of the governance check, governance metadata corresponding to the data associated with the trigger event, in which the governance metadata is associated with at least one rule base for the data associated with the trigger event, and the at least one rule base comprises one or more conditions for at least one of usage, transfer, storage, retention, deletion, or archival of the data, determine, as part of the governance check, a governance parameter based on at least one of the governance metadata, at least one event parameter associated with the trigger event, and the at least one rule base, in which the governance parameter is indicative of a governance action related to the data associated with the trigger event, and initiate performance of an evaluation of a governance action based on the governance parameter.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a diagram illustrating an example medical governance system according to various embodiments of the disclosure.

FIG. 2 is a diagram illustrating portions of an example architecture to realize functionality provided by a medical governance platform (MGP) of the medical governance system of FIG. 1 according to various embodiments of the disclosure.

FIGS. 3A, 3B, 3C, 3D, 3E, and 3F are diagrams illustrating example governance checks performed across the different blocks of the architecture of FIG. 2 according to various embodiments of the disclosure.

FIG. 4 is a flowchart illustrating a method performed by the medical governance system of FIG. 1 according to various embodiments of the disclosure.

FIG. 5 is a diagram illustrating a computer system implemented within the medical governance system of FIG. 1 according to various embodiments of the disclosure.

### DETAILED DESCRIPTION

A medical system governance platform (MGP) may include functionality to process, manage, and use medical system information and/or medical data (hereinafter “MD”), including medical device data (MDD), medical procedure related data (e.g. performed by/using medical devices), electronic health records (EHR), medical provider data, etc. MD may include various types of metadata such as parameters related to data provenance and/or data storage, including geographic parameters (e.g., country, region, state, province, etc.), organizational identifiers (e.g., as organization, division, department, provider, etc.), contract identifiers, device identifiers (e.g. MAC addresses, device names, etc.), Internet Protocol (IP) addresses (e.g. origin IP or destination IP addresses), data format(s) etc. In some embodiments, the MGP may facilitate communication (e.g. transmission and/or reception) of MD, normalization and/or transformation of the MD into various other formats, managing access to, storage of, retention, and/or deletion of MD, displaying the MD, and/or performing other functions related to the MD. The MGP may include a combination of hardware and software resources, which may be physically present at a location or distributed across one or more geographic locations. For example, the MGP may be implemented across one or more cloud systems or may be implemented as an on-premise, public and/or private cloud solution.

The MGP may transmit data to and/or receive data from multiple sources and may be responsible for system governance including governance of MD according to various laws (e.g. national, state, or local), policies (e.g. for an organization), and contractual guidelines. The laws policies, and contractual guidelines may be expressed as rules, which may be stored in one or more rule bases. In some embodiments, MGP may use applicable metadata (e.g. geography, provenance, contract identifiers, origin, destination, expected usage, etc.) to determine and associate rule bases with MD. For example, the laws, policies, and/or guidelines applicable to storage, reception, maintenance, use, transformation, transfer, retention, deletion, and/or other operations performed on or with the MD may be governed by the rule base(s): (a) associated with a contract identified by a contract identifier, and/or (b) associated with a storage location, and/or (c) associated with a requested destination, etc. The rule bases that may be applicable to the governance of the MD may be maintained and updated by the MGP. For example, the rules and guidelines may include global regulations (e.g., data storage, retention and/or transfer regulations), data use agreements (e.g., contracts), laws (e.g., privacy laws, application-related laws, health laws, and safety laws), rules (e.g., depending on a data type, the contract, the organization, and the industry), standards (e.g., security standards, industry standards, and/or organizational standards), guidelines (e.g., internal guidelines and/or industry guidelines), etc. For example, one or more contracts applicable to the data may have provisions governing the validity of the data, when the data should be archived (e.g. retention for legal reasons), discarded (e.g. because it is no longer valid for intended use), the purpose(s) associated with the data (e.g. research, diagnosis only, etc.), secondary purposes of the data (e.g. market research, machine learning, etc.), and the use of the data (e.g., who may access and how it may be used, whether the data is to be de-identified, etc.). Similarly, one or more regulations may govern the movement and storage of the data between various regions, countries, organizations, etc. Accordingly, MGP may determine and apply rules and guidelines, to ensure that MD and resource usage across a system is compliant with the applicable laws, policies, and guidelines.

In some embodiments, the MGP may also be responsible for dynamically authorizing storage, access, usage and/or other processing requests. For example, the MGP may use parameters associated with incoming requests (e.g. IP address, organization, geography, usage, requester ID/role, etc.) related to the governance of data and metadata associated with the data that is the subject of the request (e.g. provenance, contract ID, etc.) to determine applicable rule bases. In some embodiments, the MGP may use the rule bases to determine how the request (storage, access, usage, deletion, etc.) is processed. For example, MGP may determine not to grant an access request, deny a data transfer or data storage request, or initiate additional processing on data prior to a transfer based on the rule bases.

In some cases, the data at the MGP may contain high risk, sensitive information, for which even more stringent rules and guidelines may be applied. For example, the system governance at the MGP may be based on a contract with provisions indicating the use of the data for a first purpose based on the sensitivity of the data, and specify that use of the data for other secondary purposes may be restricted. As another example, governance at the MGP may be based on regional data governance and privacy regulations (e.g. associated with an incoming request and/or with the MD that is the subject of the request) as well as specific agreements related to a specified use or function associated with the MD (e.g. as indicated in contracts associated with the MD, industry standards, security, internal policies, etc.).

Any violation of these rules and guidelines may not only result in business related losses, but may also result in various types of technical problems, such as, for example, data breaches, data loss, data privacy and security errors, increased network and processor overhead, reduced efficiencies, and increased costs due to the complexities involved in resolving violations, etc. In some embodiments, the MGP may promote system and resource governance based, for example, on rules and guidelines (e.g. in a rule base) to mitigate risks and any associated resource access and/or usage.

However, in conventional systems implementing a robust and accurate governance mechanism within the MGP may be an extremely complex manual process, haphazard (e.g. due to inconsistencies in rules/guideline interpretation), and implemented non-uniformly (e.g. across different departments of an organization), thereby creating risks besides being very resource and time intensive. Analyzing the disparate rules and guidelines that may apply to various types of data (e.g. over a lifecycle) and other resources can be challenging for administrators and other professionals. For example, the governance (e.g., protection, retention, compliance, etc.) of MD within the MGP may be based on multiple different contracts, each having different provisions that may potentially overlap with one another and/or with other laws or regulations that may also be applicable. The MD may also be received from sources across different countries, states, or regions, each having a respective set of laws and regulations applicable for the governance of the data at the MGP (e.g., the data may not cross certain borders or be stored/used in certain countries). The MD may be used by different types of users (e.g., physicians, companies, etc.) for different types of purposes, and the use of the data may be governed by multiple different rules and guidelines (e.g., contractual provisions, laws, regulations, standards, industry practice, etc.). In addition, the individual data use contracts may sometimes indicate vastly different data use provisions based on different factors (e.g., the source or the type of service being provided by the MGP or hosted application). For example, the contractual provisions for a data set may indicate different data retention parameters, transfer and access parameters, use parameters for different purposes, final data asset disposition parameters, geographic storage and use parameters, etc. than other types of data assets governed by the MGP.

The present disclosure addresses the foregoing technical problems by providing an automated, transparent technical solution in the field of resource governance for medical systems. In an embodiment, the MGP may obtain and store governance metadata, which may include parameters associated with at least one of the governance of the data at the MGP, the use of the data by a client, or a transfer of the data to an external system or repository. The term “obtain” as used herein may refer to receiving, determining, deriving, or inferring. In an embodiment, the governance metadata may also be determined based on the rules and guidelines indicated in the applicable provisions of data use agreements and/or service contracts. In an embodiment, the governance metadata may also be determined based on other factors, such as, for example, a source of the data being received for storage (e.g., the location of the source and/or the entity or organization associated with the source), the requesting client of the MD (e.g., location of the client and/or the entity or organization associated with the client), an action or event being performed with the MD during the data lifecycle (e.g., landing, sharing, deletion, archival, transfer, etc.), etc. The obtained metadata may then be used to determine a governance action that may be performed at the MGP to govern the management, storage, use, and transfer of the data at the MGP.

In an embodiment, one or more governance application(s) may be provisioned in the MGP to perform governance checks on a data based on the governance metadata associated with the data. For example, the governance applications may be invoked and/or may use one or more application programming interface (API) calls (e.g., internal API calls) to access the governance metadata that is associated with the data. In an embodiment, the MGP may detect one or more events that may trigger the invocation of the governance application to perform a governance check. The one or more trigger events may be associated with data or actions to be performed with/on the data. For example, the event may occur when a request is received by the MGP from a source or client, or when an action (e.g. routine, scheduled, and/or periodic) is determined to be performed on data governed by the MGP. The MGP may obtain (e.g., receive, generate, infer, derive, store, etc.) data associated with the trigger event bases on an analysis of the trigger event or in response to data received and/or sent during the trigger event. For example, the data associated with the trigger event may be stored in the MGP, may be included in a request from a source (e.g., a request to store data at the MGP), may be included in a request from a client (e.g., a request to access data at the MGP), may be data describing the source and/or client, etc.

The governance application may then obtain (e.g., receive, infer, derive, etc.) the governance metadata for the data and/or the action, which, in some instance, may be based on the event. The governance application may obtain (e.g., receive, infer, derive, etc.) the governance metadata based on the event (e.g., an external request from the source/client), which may identify a source, a client, an action that is to be performed to the data or with the data, a requested purpose for using the data, etc. For example, a governance application may determine governance metadata based on an identifier or location associated with a source/client (e.g., as indicated in the external request), or location/destination of the data. In the example above, the governance metadata may be determined based on the location of a source of the data and intended storage location of the data, or based on a first location of a client requesting access to data stored at a second location (which may be the same as or different from the first location). Then, the governance application may also obtain governance metadata (e.g. using one or more internal API calls) to a data repository storing additional governance metadata (e.g. provenance) associated with the subject of (e.g. data identified) in the request.

The governance application may also perform a governance check on the data and/or actions requested to be performed to or with the data based on some or all of the obtained governance metadata by using a rule base to obtain governance parameters. The rule base may include one or more conditions, which when met, may trigger the governance application to generate one or more governance parameters indicating instruction(s) to perform a governance action (e.g., store data, discard data, prevent storage or further processing of data, transfer data, transfer and then discard, provide access to data, deny request to access data, etc.). The governance application may evaluate the governance parameters to, for example, determine whether to perform the governance action. The governance parameters may also include instructions to further process the data at the MGP.

The embodiments disclosed herein implement periodic governance checks based on one or more events, such that the governance checks may govern the data storage, maintenance, and use of data at the MGP. By ensuring this governance, the embodiments disclosed herein facilitate the prevention of unauthorized data transfer, access, use, or retention of data that may result in data incidents or more severe data breaches, data losses, and data privacy and security errors from occurring at the MGP. The embodiments disclosed herein also provide a framework that facilitates system governance efficiently, periodically, and in a timely fashion, while optimizing compute resource usage. For example, the embodiments disclosed herein use the governance parameters to determine whether to retain data, how long to retain the data, different storage locations for the data, when to transfer, delete or archive the data, whether to provide sharing or usage of the data, etc., thereby intelligently governing the actions at the MGP. Moreover, the MGP may facilitate more efficient use of network, storage, and processor resources, while reducing maintenance and administrator burden by automatically performing the governance checks through the data lifecycle providing systems and methods for medical system resource governance.

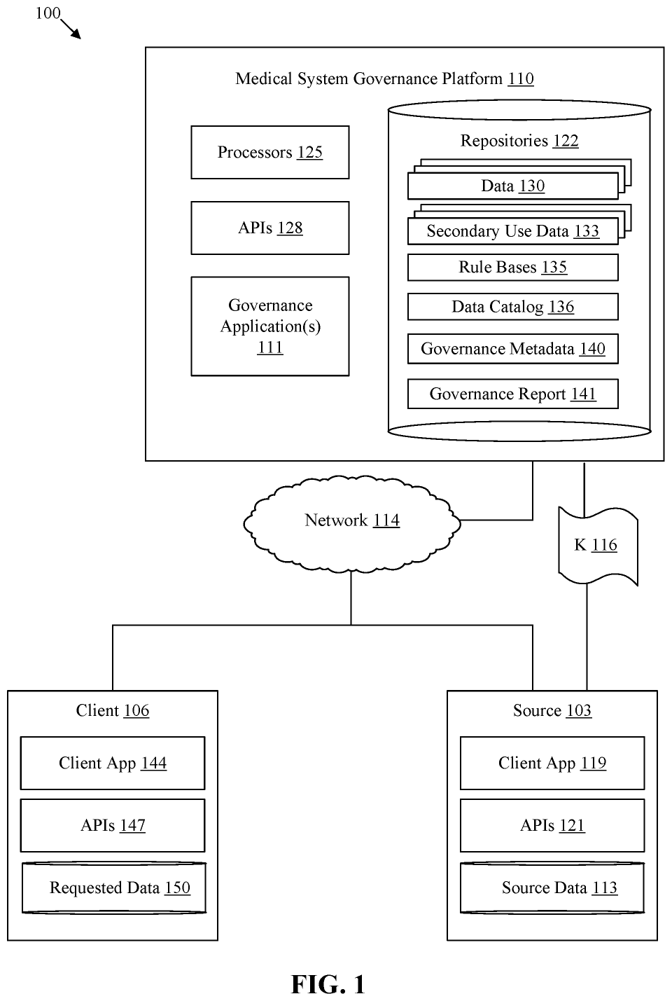

Turning now to FIG. 1, shown is a medical governance system 100 according to various embodiments of the disclosure. The medical governance system 100 comprises a source 103, a client 106, a MGP 110, and a network 114. Network 114 may be one or more private networks, one or more public networks, or a combination thereof. While FIG. 1 shows the MGP 110 as being separate from the network 114, it should be appreciated that, in some embodiments, at least a portion of the MGP 110 may be part of the network 114.

The source 103, the client 106, and the MGP 110 may be communicatively coupled via the network 114 using wired or wireless communication links. For example, the source 103 and/or the client 106 may communicate with the MGP 110 and the network 114 via a cell site, which may provide a wireless communication link to the MGP 110 and the network 114 according to a 5G, a long term evolution (LTE), a code division multiple access (CDMA), or a global system for mobile communications (GSM) wireless telecommunication protocol. For example, the source 103 and/or the client 106 may be coupled to a network element (NE), such as a router or gateway, in the network 114, which is configured to forward data to the MGP 110 and/or the governance application 111 based on addresses and identifiers.

The term “source 103” and “client 106” may each refer to one or more entities performing certain functions or roles as described below, but the functions or roles performed by the source 103 and the client 106 may change over time. It should be appreciated that the terms “source 103” and “client 106” are used in the disclosure for exemplary descriptive purposes only and should not otherwise limit the scope or functions capable of being performed by the “source 103” and the “client 106.”

The source 103 may be, for example, one or more of a server, device, computing system, NE, user equipment (UE), application, virtual private network (VPN), a repository, another MGP, etc. The source 103 may sometimes be referred to herein as a “covered entity.” In some cases, the source 103 may include storage resources (e.g., electronic files, structured data, unstructured data, formatted data assets in a relational database, etc.), processing resources (e.g., central processing units (CPUs), graphical processing units (GPUs), tensor processing units (TPUs), application-specific integrated circuits (ASICs), etc.), and/or network resources (e.g., communication interfaces, etc.). In some cases, the source 103 may be owned by a source organization or business enterprise, which may be a user or customer of the MGP 110.

The client 106 may be, for example, one or more of a server, device, computing system, NE, UE, application, VPN, a repository, another MGP, etc. In some cases, the client 106 may be owned by a client organization or business enterprise, which may also be a user or customer of the MGP 110 or may not be a user or customer of the MGP 110. For example, the client 106 may be a device at a client organization, which requests access to the MGP 110. The client organization may be the same as or different from the source organization that operates the source 103.

An operator of the MGP 110 may provide services to the source organization using functions and capabilities of the MGP 110. The source 103 may store and transmit source data 113 to be stored at the MGP 110, and the MGP 110 may perform services using the source data 113 for the source organization. In other cases, the source 103 and the MGP 110 may be owned and operated by the same organization, such that the source 103 and the MGP 110 may all be internal to an organization. For example, the source 103 may be a robotic surgical system owned by a hospital, which may be a user or customer of the MGP 110. The robotic surgical system may gather various types of source data 113, for example, related to aspects of the robotic surgical system itself (i.e., machine data) or related to procedures performed by the robotic surgical system (i.e., patient data or procedure data). The robotic surgical system may forward these different types of source data 113 to the MGP 110 for processing and for various services to be performed on or using the source data 113.

These services may be based on based on various factors, such as, for example, internal laws, policies, one or more contracts 116 (shown in FIG. 1 as “K 116”). Both the operator of the MGP 110 and the source organization of the source 103 may be parties to the contract 116 (i.e., the operator and the source organization signed the contract 116). For example, the contract 116 may indicate that the MGP 110 may be responsible for storing the source data 113, processing the source data 113 in a specified way, and analyzing the source data 113 for a first purpose or use. For example, the first purpose of the source data 113 may include operational purposes of the surgical robotic system, clinical purposes related to the procedures, research purposes for future procedures, marketing purposes for the robotic surgical system, etc. The MGP 110 may process and analyze the source data 113 based on the first purpose, and provide output as required back to the source 103. The output may include actions, information, instructions, etc. related to the use of the data for the first purpose.

For example, the output may indicate that calibration may need to be performed on a joint or arm of the robotic surgical system, an update may need to be performed on the software or firmware provisioned at the surgeon console of the robotic surgical system, etc. The output may also indicate patterns detected from the source data 113, such as, for example, patterns in the duration of knee surgeries of patients in specific age ranges, patterns detected in outcomes of surgical procedures at different joints, similarities between complications during procedures performed on certain genders or age ranges, etc. The source 103 may use the output for various purposes, such as, for example, recalibrating the system, or providing the output to one or more authorized physicians, authorized entities, etc.

In some embodiments, the source 103 may include a client application 119 and one or more application programming interfaces (APIs) 121 by which the source 103 may communicate with the MGP 110 or an application at the MGP 110. For example, the client application 119 may be an application through which a user of the source 103 may select or otherwise indicate the source data 113 to be sent to the MGP 110. The client application 119 may instruct the source data 113 to be packaged and transmitted to the MGP 110 in the form of one or more records. Each record may include one or more files, groups of files, compressed groups of files, etc. In some cases, the header of the records may include parameters and/or attributes related to the rules and guidelines applicable to the data, the source 103, the client 106, an action to be performed on or to the data, etc. For example, a header of the record may include source-related parameters, such as, for example, an address or identifier of the source 103 (e.g., an Internet Protocol address) or source organization and/or an identifier of the contract 116. The client application 119 may be instructions stored on a memory of the source 103, which when executed by a processor of the source 103, is configured to perform the foregoing functions.

While the robotic surgical system in the hospital is described herein as an example of a source 103, it should be appreciated that the source 103 may be any other device, system, or server owned by any other type of organization or business enterprise across a variety of different industries, aside from the medical technology industry. For example, the source 103 may be a system in an electronic commerce enterprise (e.g. medical supplier), and the source data 113 may be customer (e.g. patient) data, purchase histories (e.g. of a medical device), etc. As another example, the source 103 may even be a single end user or customer of the MGP 110, using the MGP 110 to store photos or personal documents in a secure manner.

The MGP 110 may refer to a platform including one or more systems and services that include hardware and/or software infrastructure designed to receive, store, manage, process, and provide data (e.g., MD) efficiently and securely. The hardware components of the MGP 110 may include physical hardware devices that store data, such as, for example, memories, hard disk drives, solid-state drives, network-attached storage, storage area networks, and cloud storage infrastructure. The MGP 110 may also include one or more software layers that are responsible for managing and processing the stored data. The software layers may include, for example, filc systems, database management systems, storage management software, and a system governance pipeline. The MGP 110 may organize data in various ways, including file-based storage, block-based storage, object-based storage, cloud-based storage, and/or other ways not otherwise limited herein. The MGP 110 may be scalable and implement many security features used to comply with data protection best practices and global data regulations related to access controls, encryption, and authentication mechanisms that may be used to protect data from unauthorized access and data incidents. The data incidents may include deletion, theft, altering, and other types of data breaches.

In some cases, the MGP 110 may be located at one or more data centers and implemented as a cloud system. In some embodiments, the MGP 110 may be distributed over multiple locations, with each location being a different data center. Alternatively, the MGP 110 may be positioned at a single storage location, in which the storage location may be a data center, or may be any other location with physical or virtual data storage resources.

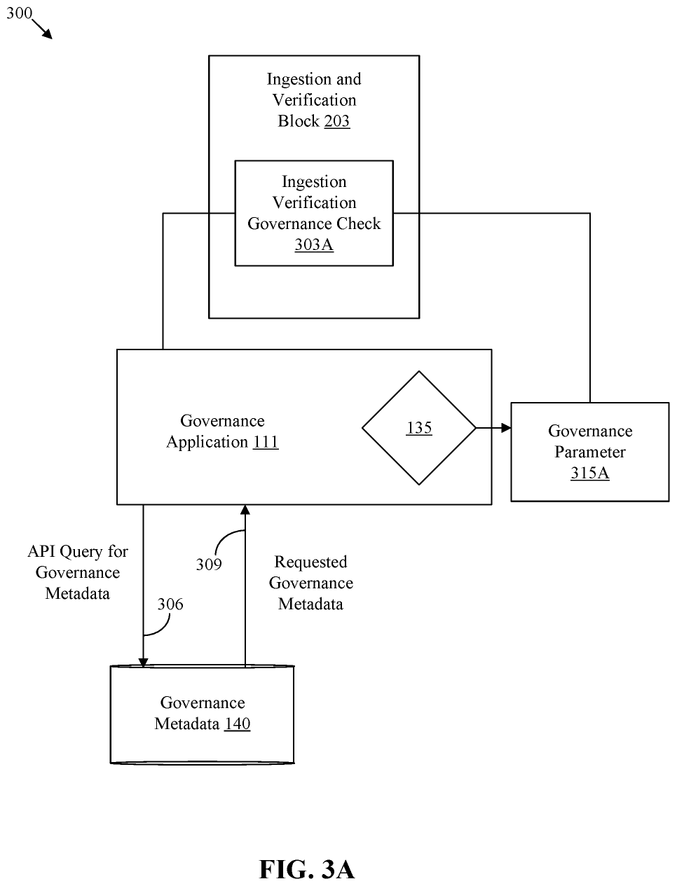

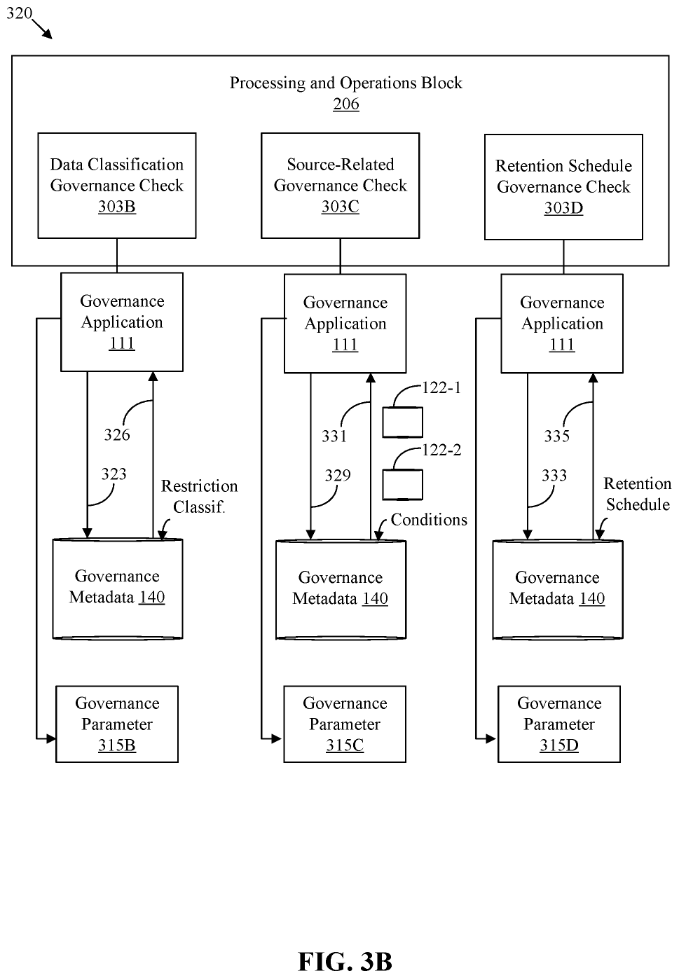

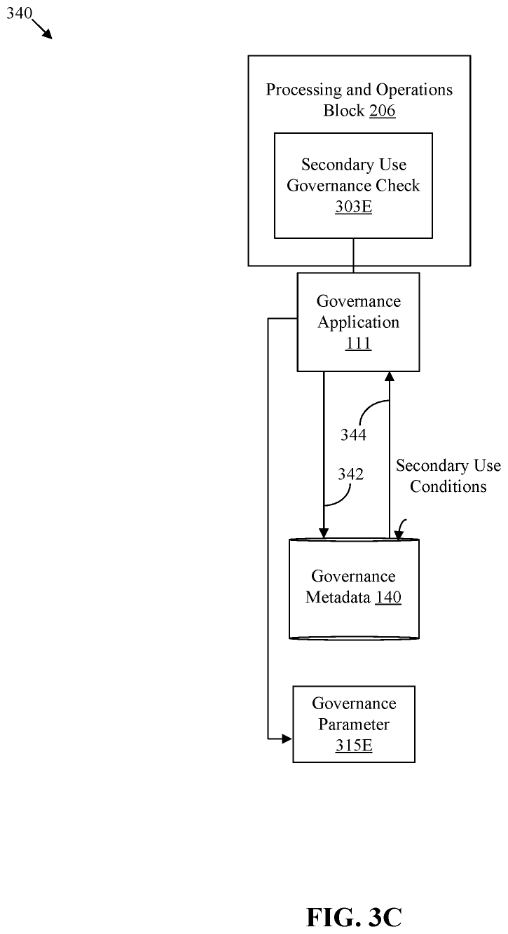

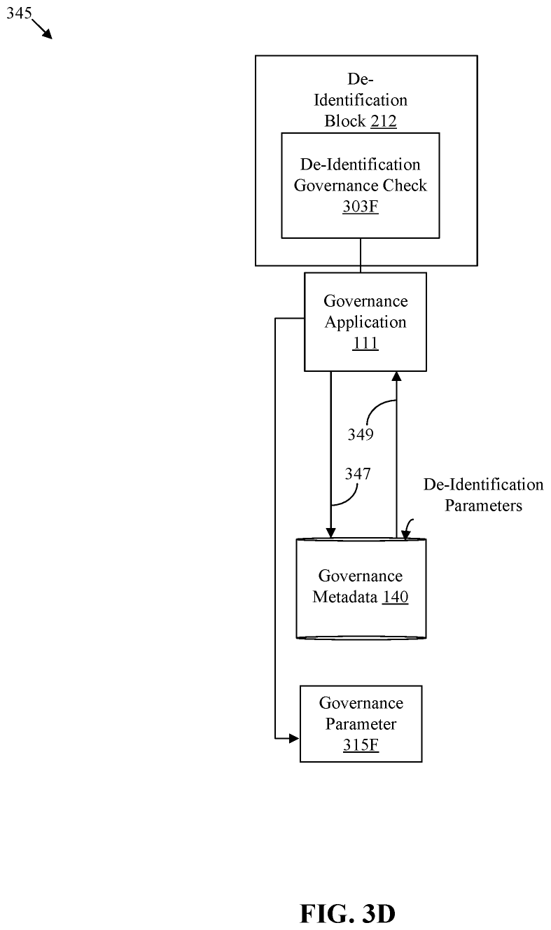

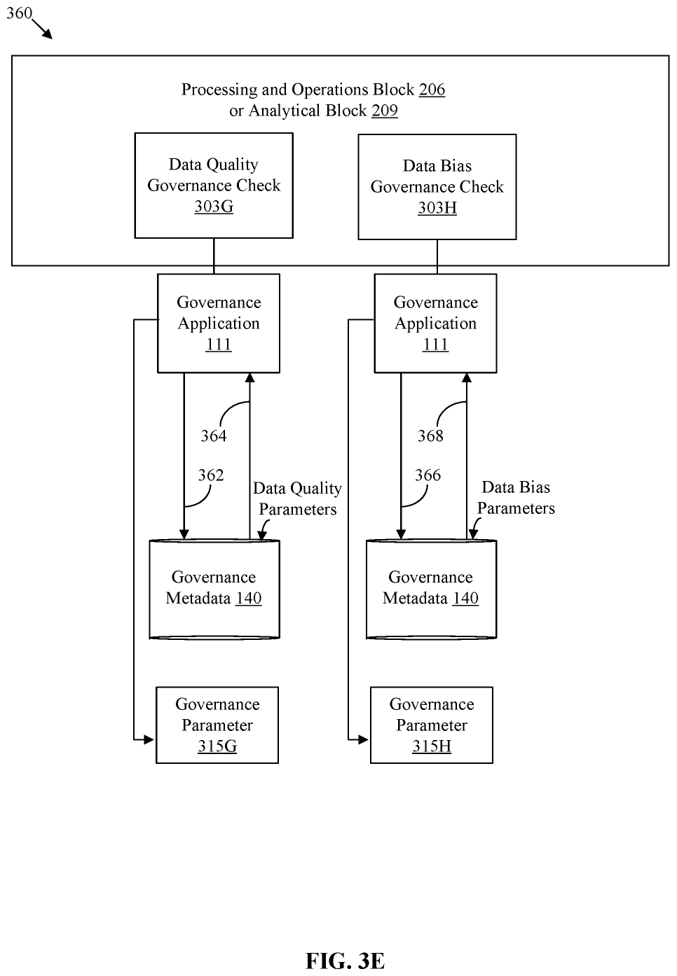

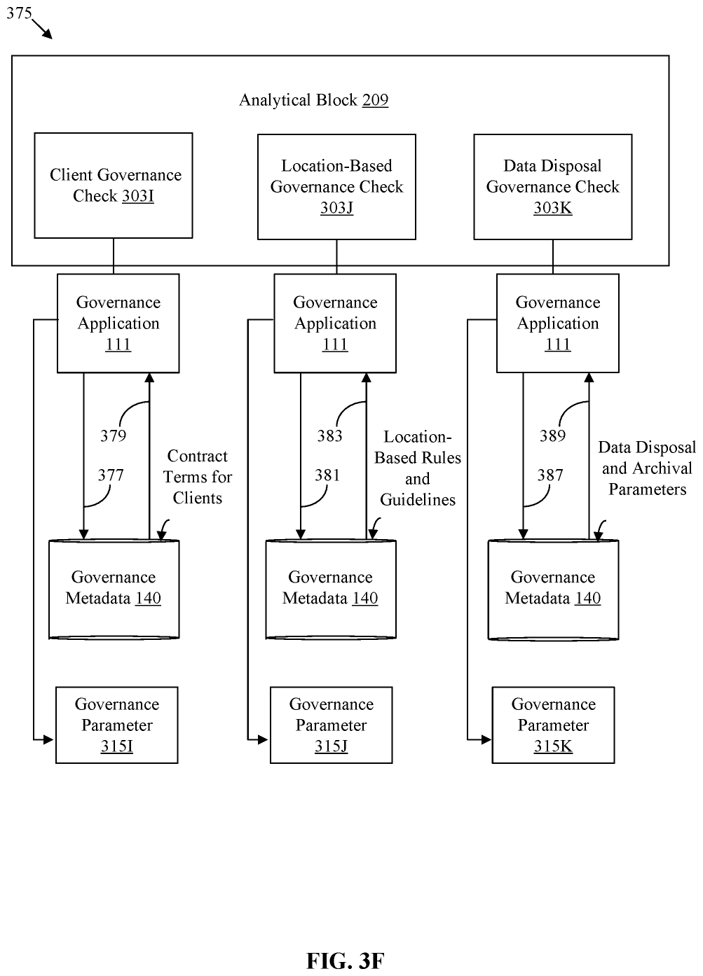

As shown in FIG. 1, the hardware components of the MGP 110 may include one or more repositories 122 (e.g., one or more memories), processors 125, and APIs 128. As should be appreciated, the MGP 110 may include other components not otherwise shown in FIG. 1 or described herein. The repositories 122 may store data 130, secondary use data 133, a data catalog 136, a governance report 141, governance metadata 140, and rule bases 135. The repositories 122 may include a source repository 122-1 (also referred to herein as a “first repository 122-1”) and a destination repository 122-2 (also referred to herein as a “second repository 122-2”), both of which are illustrated in FIG. 3B. The destination repository 122-2 may be separate from and external to the source repository 122-2 and/or the MGP 110 (e.g., the destination repository 122-2 may be located in the same MGP 110 or at a different MGP). For example, data 130 received from a source 103 may be stored at the source repository 122-1, and the MGP 110 may govern the transfer/movement of the data 130 to the destination repository 122-2.

While the data 130, secondary use data 133, data catalog 136, governance report 141, and governance metadata 140 are shown as being physically stored in the same repository 122, it should be appreciated that the data 130, secondary use data 133, rule bases 135, data catalog 136, governance report 141, and governance metadata 140 may be stored in physically separate locations across multiple data stores, databases, and even geographic locations. Meanwhile, it should also be appreciated that the data 130, secondary use data 133, rule bases 135, data catalog 136, governance report 141, and governance metadata 140 may logically be stored together in the same environment, but in different data structures with specific access control and data protection for case of management, querying, and analysis using various logical data storage techniques, such as, for example, addressing schemes, data virtualization, database partitioning, distributed architectures, etc.

The data 130 may include source data 113, received from multiple different sources 103, each of which may be users of the MGP 110 (including hospitals and other “covered entities”) or customers. In some cases, the customers may be engaged in a contract 116 with an operator associated with the MGP 110, such that the MGP 110 performs system governance. The data 130 may be the same as the source data 113 received from the sources 103, or in some cases, include raw source data. Alternatively, the data 130 may include similar contents as the source data 113, but may be reformatted, normalized, encrypted, or otherwise processed in various ways for storage purposes.

In some cases, the data 130 may be de-identified using one or more de-identification processes (sometimes referred to as “anonymization processes”) to remove the risk of reidentification of a data subject from the data 130. The de-identification processes described herein may include removing personally identifiable information from the data 130 and/or may also include removing other types of identification information (e.g., hospital identification, physician identification, schedules, etc.) from the data 130. In some cases, the MGP 110 may perform the de-identification processes on the data 220 while complying with the applicable rules and guidelines for performing de-identification on the data. The applicable rules and guidelines may be based on regional/country regulations or organizational guidelines that may indicate a de-identification risk score threshold for which evidence may be requested. Performing de-identification processes on the data 130 may transform the data into secondary use data 133. The secondary use data 133 may include the same content as the corresponding data 130, but the secondary use data 133 may not include identification data that might otherwise pose a security or privacy risk, or possibly break regulations regarding patient privacy. For example, the data 130 may be patient data associated with a particular surgeon and/or patient, and Health Insurance Portability and Accountability Act (HIPAA) regulations may govern the storage and use or the personally identifiable information that may be included in this patient data. The processor 125 may perform the de-identification process by transforming the data 130, sometimes repeatedly, until a risk score, or a value indicating a risk of reidentification, is below a threshold value. The de-identification process may mitigate much of the risk of re-identification of a data subject in accordance with regional regulations and data protection standards. In this way, the secondary use data 133 may include much of the same data as the corresponding data 130, but may include a relative low risk of re-identification, such that the secondary use data 133 may be used by other clients 106, sometimes for purposes other than the first purpose (e.g., as indicated in a contract 116), as further described herein. HIPPA is merely an example, and various other regulations such as, for example, international (General Data Protection Regulations in the European Union (EU)), national, state, and local laws may also govern data and resource usage.

The data catalog 136 may refer to a centralized repository storing information about the data 130 and secondary use data 133 stored in the MGP 110. The data catalog 136 may serve as a catalog or inventory of available data assets and may provide metadata/context to help sources 103 and clients 106 discover, understand, and effectively use the data 130 and/or the secondary use data 133. In some cases, the data catalog 136 may include basic metadata describing the data 130 and/or the secondary use data 133. For example, the basic metadata may indicate the source 103, format, schema, data lineage, timestamps, owner, quality metrics, etc. regarding the data 130 and/or the secondary use data 133, in a user-friendly readable format. The data catalog 136 may also include analytics and reporting features to track data usage, popularity, and access patterns. Users may search the data catalog 136 to discover the data 130 and the secondary use data 133 and files stored in the MGP 110. The data catalog 136 may also include the governance metadata 140 described herein.

In some cases, clients 106 may wish to receive access to the data 130 or secondary use data 133 stored at the MGP 110. In some embodiments, the client 106 may include a client application 144 and one or more APIs 147 by which the client 106 may communicate with the MGP 110, governance application 111, or any other application at the MGP 110. For example, the client application 144 may be an application through which a user of the client 106 may select requested data 150 to request and retrieve from the MGP 110. The client application 144 may be instructions stored on a memory of the client 106, which when executed by a processor of the client 106, is configured to perform the operations of selecting the requested data 150 to request from the MGP 110, and transmitting a record requesting the requested data 150 from the MGP 110. The header of the record may include an address or identifier of the client 106 or the client organization operating the client 106.

The MGP 110 may process the requests for requested data 150 received from the client 106 based on one or more of, for example, event parameters associated with the client 106, a risk level of the requested data 150, a purpose of using the requested data 150, etc. For example, the MGP 110 may provide the requested data 150 from the data 130 (e.g., low risk level data that may not have been de-identified) based on whether the client 106 is authorized to receive the data 130, when the risk level of the data 130 is low, and/or when the purpose of using the data 130 is the first purpose (e.g., indicated in a contract 116). This may be based on one or more contracts 116 between the source 103 and the MGP 110, which may indicate the first purpose for which the data 130 may be used in a de-identified form. The contracts 116 may also indicate additional purposes or uses of the data 130, for which de-identification may need to be performed on the data 130 (e.g., to create secondary use data 133) before the secondary use data 133 may be transmitted to the requesting client 160. In contrast, the MGP 110 may provide the requested data 150 from the secondary use data 133 (e.g., higher risk level data that may have been de-identified to be low risk) based on whether the client 106 is authorized to receive the data 130 and/or when the purpose of using the data 130 is not the first purpose, but instead a secondary purpose different from the first purpose. For example, the first purpose for data 130 may be for system maintenance purposes, and any purpose other than the system maintenance purpose (e.g., advertisement, research, etc.) may be considered a secondary purpose.

However, in some cases, the data 130 and/or the secondary use data 133 may be stored, processed, and/or provided to clients 106 in a manner that violates the rules and guidelines governing the data 130 and the secondary use data 133 at the MGP 110. The rules and guidelines governing the data 130 at the MGP 110 may be based on, for example, terms and provisions in the contracts 116, regulatory conditions (e.g., laws and regulations pertaining the storage of the data), industry standards, or internal policies, each of which may govern the storage, processing, and access to the data 130 and the secondary use data 133 at the MGP 110. For example, contracts 116 may have terms and provisions, such as, for example, expiration dates (e.g., the contract 116 may be valid for one year), secondary use parameters (e.g., use of the data 130 regulated for certain secondary purposes, such as advertising or marketing), geographical parameters (e.g., data 130 may not be received from a source 103 at certain geographical areas, regions, etc., data 130 may not be transmitted to a client 106 at certain geographical areas, regions, etc.), artificial intelligence use parameters (e.g., machine learning may not be performed on certain types of data 130), data lifecycles, archival and disposal instructions (e.g., indicating when data may be archived or disposed of instead of being retained at the MGP 110), etc. These terms and provisions may facilitate governing the storage, access, permissions, archival, disposal, and other actions that may be taken by the MGP 110 with respect to the data 130 and the secondary use data 133. Similarly, governmental regulations may be imposed on the MGP 110, based on, for example, the type of data 130/secondary use data 133 being stored, a location of the repositories 122 storing the data 130/secondary use data 133, the owner/operator of the MGP 110, etc. For example, certain countries may have a regulation that data stored at that country may not move outside that country. Any violation of these rules and guidelines may result in contractual breaches, lawsuits, negative branding effects, legal penalties, reputational damages, operational disruptions, financial consequences, loss of business opportunities, and more. Similarly, violations of these rules and guidelines may also result in the security of sensitive data being compromised, and possibly even data breaches.

To mitigate these risks, organizations may prioritize compliance with the rules and guidelines applicable to the data 130/secondary use data 133 in the MGP 110. However, in conventional systems, implementing a robust compliance mechanism within the MGP 110 may be heavily resource and time intensive. For example, implementing a contractual term/provision governance process within a conventional medical system may involve an iterative and sequential search of the contracts to identify relevant terms and provisions. Similarly, implementing a governmental regulation governance process may be heavily resource and time intensive because the process may involve a detailed search and analysis of the applicable laws and regulations. Moreover, the process may consume an unnecessary amount of network capacity due to the back and forth network communications involved in contractual and regulatory compliance.

The present disclosure addresses the foregoing technical problems by providing a technical solution in the field of governance for medical systems. In the embodiment shown in FIG. 1, the MGP 110 may include a governance application 111 that may be responsible for implementing a governance method. The governance method may efficiently and effectively ensure that certain actions performed at the MGP 110 and access requests granted by the MGP 110 comply with the rules and guidelines guiding the governance at the MGP 110.

In some embodiments, the governance application 111 may obtain or determine governance metadata 140 in various different ways based on a variety of different factors. For example, the variety of different factors may include a geography (e.g., a region), a location (e.g., a hospital that is, for example, in contract 116 with the MGP 110), a device (e.g., a robotic system used at the hospital), one or more rules (e.g., a device malfunction or other condition that may be reported and used for analysis, procedures (e.g., may include personally identifiable information), etc.

For example, the governance application 111 may determine the governance metadata 140 based on an event (e.g., receiving a request for storing data from a source 103, receiving a request for accessing data from a client 106, receiving a record including identifiers related to a contract 116, etc.). The governance metadata may include identifiers and/or locations of the source 103 or client 106, terms of the contract 116, etc., each of which may be extracted from the aforementioned requests or records.

The governance application 111 may also determine the governance metadata 140 for a dataset based on, for example, governance documents, files, websites, or databases, each of which may indicate rules and guidelines applicable for governing data 130 in the MGP 110. For example, the rules and guidelines of the governance metadata 140 may include data describing terms/provisions of contracts 116, applicable provisions in governing laws and regulations, industry standards, and internal policies with which a dataset may comply to be consistent with the contracts 116, laws and regulations, service level agreements (SLAs), industry standards, and/or internal policies.

For example, the governance metadata 140 may include the terms and provisions of the contract 116, which the MGP 110 may comply with to be consistent with the contract 116. For example, the governance metadata 140 may include data describing an identification of the parties, a term of the contract (e.g., effective date and termination date), storage and transfer parameters, access parameters, use parameters, archival parameters, disposal parameters, security parameters, risk parameters, etc.

The governance metadata 140 may also include data describing parameters related to government regulations that are applicable to the MGP 110, which the MGP 110 may comply with to operate in accordance with the government regulations. Government regulations may be applicable to the MGP 110 based on, for example, the type of data 130/secondary use data 133 being stored, a location of the repositories 122 storing the data 130/secondary use data 133, the owner/operator of the MGP 110, etc. For example, the governance metadata 140 may include data describing geographical movement parameters, data type storage parameters, high risk data classifications, data sharing parameters, etc.

The governance metadata 140 may be formatted as any type of data structure that may store data describing the parameters (e.g., rules and guidelines) applicable to the data 130 and secondary use data 133 at the repositories 122. For example, the governance metadata 140 may be formatted as a text document, extensible Markup Language (XML) document, table, list, stack, queue, linked list, tree, heap, graph, matrix, blockchain, etc.

The governance application 111 may obtain and store the governance metadata 140 in a variety of different ways and based on a variety of different factors. For example, the governance metadata 140 may be a document generated by one or more operators of the MGP 110. The governance application 111 may obtain the governance metadata 140 by receiving the governance metadata 140 from the operators and storing the governance metadata 140 in the repositories 122. For example, this process may be performed by manually extracting the attributes and values from a contract 116 or using an automated process as described below, or various combinations thereof.

As another example, the governance application 111 may generate the governance metadata 140 based on an analysis of a text document of the contract 116 and one or more documents, files, databases, etc. containing government regulations, industry standards, internal policies, and/or other parameters that may or may not be applicable to the MGP 110. For example, the governance application 111 may apply natural language processing (NLP), large language modeling (LLM), robotic process automation (RPA), and/or other forms of artificial intelligence/rule-based language modeling, to identify the terms and provisions in the contract 116 and regulations that may be added to the governance metadata 140. In some instances, the processes above may be supplemented by human input and/or review. Accordingly, the governance application 111 may obtain the governance metadata 140 and may store the governance metadata 140 into the repositories 122 of the MGP 110.

The governance metadata 140 may also be programmed to receive and respond to internal API calls and requests from the governance application 111 and/or external API calls and requests from the sources 103 and/or clients 106, using the APIs 128 and 147, for example. The governance application 111 may access the governance metadata 140 using internal API calls via, for example, APIs 128 and 147. The governance application 111 may evaluate an action performed at the MGP 110 or an access request received by the MGP 110 based on the governance metadata 140 and a rule bases 135.

The rule bases 135 may refer to rules or conditions related to the governance metadata 140 or applicable rules and guidelines. The rule bases 135 may include one or more conditions, which when met, may trigger the governance application 111 to perform a governance check on data or an action at the MGP. The governance check may output a governance parameter indicating an instruction to perform a governance action, as further described herein. The governance application 111 may also be responsible for performing or instructing the performance of the governance actions based on a result of the foregoing determination. Various examples of the governance application 111 performing evaluations using the governance metadata 140 are further described below with reference to FIGS. 3A-F.

The governance application 111 may send an internal API request to access the governance metadata 140 in response to one or more events. For example, the events may be based on at least one of a timing indicated in a preset schedule for performing governance checks on the data, receiving a request to perform the governance check on the data from a client 106, detecting an event related to the data, etc. For example, the event related to the data may be based on receiving the data from a source 103, processing the data for data quality, detecting an approaching archival or disposal time for the data, receiving a request to transfer the data to another geographic location for load balancing purposes, or receiving a request to use the data for at least one of a first purpose, one or more secondary use purposes, an artificial intelligence modeling purpose, or an analytical purpose.

The preset schedule may be pre-configured by an operator of the MGP 110 to perform governance checks on the data 130 or secondary use data 133 stored at the repositories 122. The preset schedule may also be user-configurable or operator-initiated. For example, the governance application 111 may perform a governance check on data 130 once a week or once a day to ensure that the data quality complies with the parameters indicated in the governance metadata 140. As another example, the governance application 111 may perform a governance check on secondary use data 133 once a week to ensure that the secondary use data 133 has been de-identified according to a risk score indicated in the governance metadata 140.

Clients 106 may also send requests to the governance application 111 for data stored at the MGP 110. For example, a client 106 may send, via the client application 144 directly to the governance application 111, requests for access to secondary use data 133. The governance application 111 may first query the governance metadata 140 to make a determination regarding the request from the client 106 to access the secondary use data 133 using the rule bases 135, as further described herein. The governance application 111 may then return a response to the client 106 regarding the request from the client 106 to access the secondary use data 133. This request and response may be exchanged before the client 106 actually attempts to access the secondary use data 133 at the MGP 110, to prevent inaccessible data requests from flooding the MGP 110.

The governance application 111 may also independently transmit information to the source 103 to notify the source 103 regarding the parameters indicated in the governance metadata 140. For example, the contract 116 may indicate an expiration date or termination date approaching within a period of time (e.g., 90 days, 60 days, 30 days). The governance application 111 may transmit a notification to the source 103 indicating that the contract 116 is expiring within a period of time. The governance application 111 may be programmed to send such notifications to the source 103 periodically. Similarly, the governance application 111 may also detect when data 130 indicates that a machine associated with the source 103 is malfunctioning, and the governance application 111 may detect, based on the governance metadata 140, that the malfunctioning of the machine may need to be reported to a federal agency. The governance application 111 may forward the data 130 to the source 103 and/or the federal agency as a method of complying with the regulation. In this way, the governance application 111 may also be responsible for notifying the source 103 regarding any contract 116 terms or provisions, impending contract 116 events (e.g., termination, renewal) and complying with regulatory reporting requirements and dates, etc.

While the governance application 111 is shown as being included in the MGP 110 in FIG. 1, it should be appreciated that in some embodiments, the governance application 111 may also implemented as separate from of the MGP 110. For example, the governance application 111 may be instructions stored on a memory of another server, which when executed by a processor 125 of the server, causes the governance application 111 to send internal API calls to the governance metadata 140 and perform governance checks as disclosed herein.

The data 130 and/or secondary use data 133 may be tagged with the governance metadata 140, such that the governance metadata 140 may be logically stored together with the corresponding data 130 (although physically separate). The correlation between the data 130 and/or secondary use data 133 and the corresponding governance metadata 140 may also be indicated in the data catalog 136. In this way, the data catalog 136 may maintain descriptive governance metadata 140 for the data 130 and/or secondary use data 133 with the corresponding governance metadata 140. For example, the data catalog 136 may include a compliance entry for each data or type of data that originated from different sources 103. The compliance entry may indicate, in text format, the parameters (e.g., rules and guidelines) governing the storage and use of the data 130/secondary use data 133 in the MGP 110. For example, the data catalog 136 entry for a particular data set may include an entry indicating a termination date of the contract 116, geographical parameters, access parameters, storage parameters, use parameters, etc. These entries may be formatted as textual statements, which the user may read or search through to understand the compliance requirements for the dataset.

In some cases, the data 130 and/or secondary use data 133 may be moved to a different location. For example, the different location may be within the same MGP 110 but at a different repository 122, to a different MGP, or may even be moved to a different location within the same repository 122. New governance metadata 140 may be obtained for the newly applicable rules and guidelines governing the data 130 and/or secondary use data 133 at the different location.

In an embodiment, the governance application 111 may generate a governance report 141 for the data 130/secondary use data 133 based on information and records related to each of the governance checks performed on the data 130/secondary use data 133. For example, the governance application 111 may maintain a log of the governance checks performed on the data 130/secondary use data 133, and record governance parameters for each of the governance checks. The governance parameters may indicate a value associated with one or more governance checks (e.g., in which the parameter may be evaluated to perform an action on the data 130/secondary use data 133, perform an action with the data 130/secondary use data, provide access to the data 130/secondary use data 133, etc.). The governance parameters may also indicate subsequent actions that are to be performed on the data 130/secondary use data 133 based on the governance check (e.g., further processing of the data 130/secondary use data 133, disposal/archival of the data 130/secondary use data 133, etc.). In this way, the governance report 141 may provide an indication regarding whether the data 130/secondary use data 133 in the MGP 110 is consistent with the rules and guidelines governing the data 130/secondary use data 133. The governance report 141 may include documentation, logs, reports, and other evidence that may be used to verify and prove compliance with the rules and guidelines.

In this way, the embodiments disclosed herein may ensure that the actions taken by the MGP 110 and access to the MGP 110 complies with the rules and guidelines applicable to the governance of the data 130/secondary use data 133 at the MGP 110. The embodiments disclosed herein also ensure that such governance is monitored, enforced, and recorded in a resource efficient and effective manner. The governance metadata 140 may essentially be used for all governance related purposes (e.g., protection, retention, and compliance purposes), such that any queries related to governance and any governance checks may all be performed using API calls to the governance metadata 140. By directing all governance related actions to the governance metadata 140, as opposed to different sites and entities throughout the system, network capacity may be greatly increased. Moreover, the governance application 111 may be equipped with the processing and power resources, either as a separate computing system or with the MGP 110, to handle the compliance determinations in a processing efficient manner (i.e., without needing to repeatedly search through the contract 116 and various regulatory documents/files).

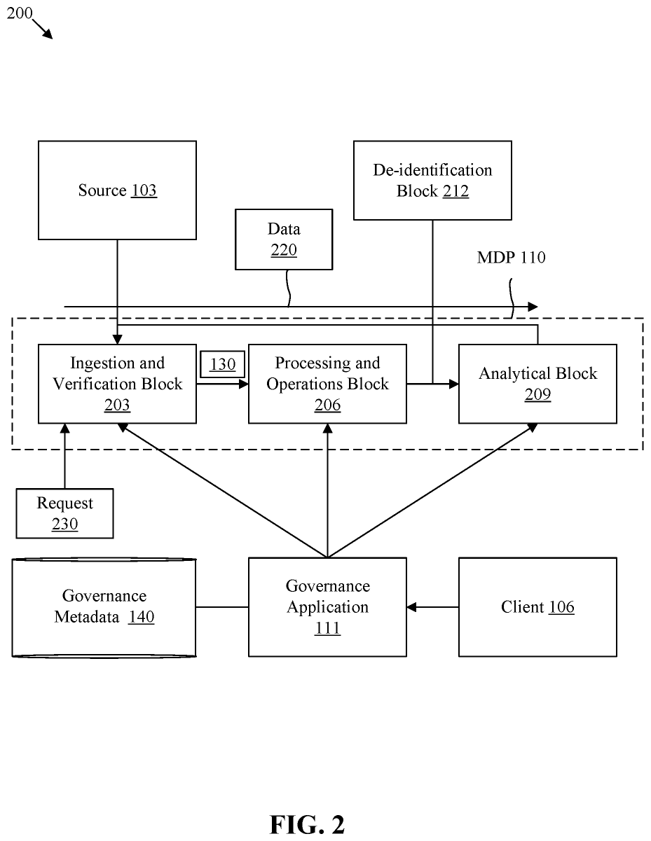

Turning now to FIG. 2, shown is a diagram illustrating a system governance pipeline 200 implemented by the MGP 110 of FIG. 1 according to various embodiments of the disclosure. The system governance pipeline 200 may refer to architecture utilized to realize functionality by the MGP 110 of the medical governance system 100. The system governance pipeline 200 may refer to a series of interconnected system governance operations performed on the source data 113 received from the source 103 to obtain the data 130 and/or the secondary use data 133 and to process the data 130 and/or the secondary use data 133. The system governance pipeline 200 may enable the collection, transformation, storage, and analysis of data 130 at the MGP 110. As shown in FIG. 2 and further described herein, the governance application 111 may leverage the governance metadata 140 to perform one or more governance checks on the data 130, the source 103, the client 106, and/or on actions that are to be performed on or with the data 130. The governance checks may be related to the storage, protection, use, and retention of the data 130/secondary use data 133 (hereinafter occasionally referred to as data 220), as further described below with reference to FIGS. 3A-F.

The system governance pipeline 200 may include a sequence of one or more blocks (or zones), in which different operations may be performed on the data being passed through the respective block. FIG. 2 illustrates examples of the blocks included in the system governance pipeline 200. Specifically, the blocks of the system governance pipeline 200 shown in FIG. 2 includes the ingestion and verification block 203, the processing and operations block 206, and an analytical block 209. In some cases, a de-identification block 212 may also be included in the system governance pipeline 200 before the data begins processing in the analytical block 209. In some cases, data produced by the analytical block 209 may re-ingested into the system governance pipeline 200 and/or the MGP 110 with, for example, lineage information.

The ingestion and verification block 203 may be the initial stage of the system governance pipeline 200, in which the source data 113 is received (i.e., ingested) from the source 103. The source data 113 may be received from a variety of different sources 103 in the form of an incoming request 230, such as, for example, the robotic surgical system discussed above, Internet of Things (IoT) devices, applications, users, or other external systems. The incoming request 230 may be an external request received from an entity external to and separate from the MGP 110. The source data 113 included in the incoming request 230 may be in different formats and structures.

The source data 113 may be stored, for example, into a database dedicated for the source 103, or parameters may be stored in the database to associate the source data 113 with the source. For example, the MGP 110 may include various databases logically reserved for different sources 103 or associated with an identifier or address of the source 103, such that source data 113 received from different sources 103 are stored within the respective logical database for that source 103.

In some cases, the source data 113 may be processed in the ingestion and verification block 203, in which the processing operations may vary depending on the architecture and requirements of the MGP 110. For example, processing operations performed on the source data 113 in the ingestion and verification block 203 may include data validation and cleansing, data format transformation, data restructuring, data encryption and security, data deduplication, etc. Data 130 may be obtained when source data 113 has been processed through the ingestion and verification block 203 and may be ready to flow into the processing and operations block 206. In some cases, the MGP 110 may reject the incoming request 230, and thus deny processing/storage of the source data 113 in the request 230 based on certain conditions (e.g., prohibited source 103, impermissible type of source data 113, MGP 110 attributes, etc.). In such a case, the MGP 110 may discard (or prevent storage and/or further processing of) the source data 113 from the request 230, and may send a rejection notification to the source 103 indicating a reason for rejection.

In the processing and operations block 206, the data 130 may be processed to support real-time or near-real-time operational tasks and applications, for example, based on the first purpose indicated in the contract 116. The data 130 in the processing and operations block 206 may be processed and optimized for quick data retrieval, updates, and transactions. For example, operations performed on the data 130 in the processing and operations block 206 may include data storage, real-time processing, data indexing, data updating, data replication, data quality optimization, caching, monitoring and alerting, etc. In some embodiments, data 130 may also be processed for low-latency access, rapid updates, and decision-making capabilities by processing and operations block 206.

As described above, clients 106, which may also include sources 103, may request access to data 130 stored in the MGP 110. In some cases, clients 106 may request use of the data 130 for a purpose outside of the first purpose indicated in the contract 116 (i.e., the client 106 may request secondary use of the data 130). As described herein, the governance application 111 may perform one or more governance checks at this stage to determine whether the client 106 is authorized to access the data 130 for the first purpose, whether the data 130 may be converted to secondary use data 133, and/or whether the client 106 is authorized to access the secondary use data 133 for a secondary purpose. When the data 130 is provided to a client 106 for a secondary use in some cases, the data 130 may enter the analytical block 209 of the system governance pipeline 200.

In the analytical block 209, data 130 may be processed and analyzed to derive insights, generate reports, and support business intelligence and data analytic activities. For example, operations performed on the data 130 in the analytical block 209 may include data extraction, data transformation, data modeling, analytics and reporting, machine learning and predictive analysis, archiving and disposal, performance optimization, etc.

In some cases, secondary use of the data 130 may be facilitated by de-identification processes to reduce a risk score (likelihood or level of risk associated with the re-identification of individuals within corresponding data 130) to below a threshold. The de-identified data (e.g. data 130 subsequent to deidentification) may take the form of corresponding secondary use data 133. A de-identification block 212 may refer to the de-identification processes described herein that may be performed on the data 130 to obtain the secondary use data 133. For example, the de-identification process may refer to any process that may be performed to remove or obfuscate personally identifiable information (PII) and other sensitive data elements while preserving the utility of the data for analysis. The secondary use data 133 while including content similar to the corresponding data 130, may be utilized for secondary use operations without the risk of re-identification.

In some embodiments, the governance application 111 may perform various governance checks as the data 220 (i.e., source data 113, data 130, and/or secondary use data 133) passes through the block 203, 206, 209, and 212 of the system governance pipeline 200, based on requests from clients 106 to access the data 220 at the MGP 110, based on requests from sources 103 to store the data 220 at the MGP 110, or based on actions to be performed on the data 220 or with the data 220. A governance check may refer to the process of evaluating whether the storage, management, and use of data 220 in the MGP 110 is consistent with to the rules and guidelines governing the storage, management, and use of the data 220 (e.g., relevant laws, regulations, industry standards, contractual obligations, internal policies, etc.). For example, each of the governance checks may be related to an applicable regional or country data governance regulations, the governance checks may correspond to contractual provisions based on the contract 116, or the governance checks may correspond to service level agreement (SLA) governance checks based on SLAs associated with an entity of the data 220 and/or 130.

The governance application 111 may perform the governance checks as the data 220 passes through the system governance pipeline 200 based on the governance metadata 140. As described above, the governance metadata 140 may be obtained in various ways, which may involve identifying applicable terms/provisions from contracts 116, regulations, industry standards, internal policies, etc., identifying action(s) to be performed on or using the data 220, and then adding the received and/or determined information to the governance metadata 140. In some embodiments, governance metadata 140 may be accessed and retrieved by entities using API calls provided, for example, by the governance application 111.

As further described below with reference to FIGS. 3A, 3B, 3C, 3D, 3E, and 3F, the governance application 111 may perform governance checks at various points along the system governance pipeline 200 based on the occurrence of one or more events, which may trigger the performance of a particular governance check. For example, an event may occur when the data 220 is ingested at the ingestion and verification block 203, an event may occur upon data 220 modification (e.g. formatting, reformatting, etc.), an event may occur upon data quality updating, etc. Similarly, events may be based on a preset schedule or triggered by request(s), to ensure that governance mechanisms continue to operate and the data 220 remains compliant through the lifecycle of the data 220.

Turning to FIGS. 3A, 3B, 3C, 3D, 3E, and 3F, shown are diagrams illustrating examples of governance checks performed throughout the system governance pipeline 200 and/or in response to requests received from clients 106. The clients 106 may refer to the sources 103 of the data 220 or third parties requesting access to the data 220. As used herein, the term “data 220” may refer to any type of data stored at the MGP 110, including source data 113, data 130, and/or secondary use data 133.

The governance checks shown in FIGS. 3A, 3B, 3C, 3D, 3E, and 3F are examples described for illustrative purposes only. It should be appreciated that the governance application 111 may perform other types of governance checks not otherwise described herein based on governance metadata 140. Some of the governance checks shown in FIGS. 3A, 3B, 3C, 3D, 3E, and 3F are described with respect to being performed in a particular block 203, 206, 209, and 212 of the system governance pipeline 200. However, it should be appreciated that any of the governance checks described herein may be performed anywhere along the system governance pipeline 200 in any particular order (e.g., based on a request, ad hoc programmatic check, or based on a preset schedule). Moreover, not all of the governance checks described in FIGS. 3A, 3B, 3C, 3D, 3E, and 3F may be performed, but rather in some cases, only one or a subset of the governance checks described in FIGS. 3A, 3B, 3C, 3D, 3E, and 3F may be performed.

Referring now to FIG. 3A, shown is a sequence diagram 300 illustrating a governance check 303A performed in the ingestion and verification block 203. The governance check 303A (also referred to herein as the “ingestion verification governance check 303A”) may be performed in response to an event, which may occur when the source data 113 is received from the source 103 and stored in a database at the MGP 110, for example, in a request 230 including the source data 113.

In response to detecting the event of the source data 113 being received from the source 103 with a request to store source data 113 at the MGP 110, the governance application 111 may be triggered. In some embodiments, governance application 111 may perform the ingestion verification governance check 303A based on governance metadata 140. To perform the ingestion verification governance check 303A, the governance application 111 may evaluate data associated with the event (e.g., event description, type/nature of the event, the source of the event, the request (e.g. to store the source data 113 at the MGP), etc.), and the governance application 111 may make a determination regarding the governance (e.g., storage) of the source data 113 at the MGP 110 based on the governance metadata 140, the data associated with the event, and various conditions. For example, the conditions may be whether the source 103 is a valid source and/or a customer of the MGP 110, and whether the contract 116 between the organization of the source 103 and the operator of the MGP 110 is valid (i.e., not expired).

Accordingly, in some embodiments, at operation 306, the governance check 303A may involve the governance application 111 obtaining governance metadata 140. The governance application 111 may determine governance metadata 140 (e.g., source-related parameters) based on, for example, the request received from the source 103. For example, the governance application 111 may determine governance metadata 140 such as an identifier of the source 103, an address of the source 103, a location of the source 103, etc., based on the request received from the source 103. The governance application 111 may also transmit an (internal) governance metadata request (e.g., via one or more internal API calls or internal API requests) for governance metadata 140 in the ingestion verification governance check 303A. The governance metadata request made by the governance application 111 for the governance metadata 140 may include an indication of the specific governance metadata 140 sought and information on the received source data 113. For example, the governance metadata request may include an indication that the request is for an expiration date or a term of the contract 116 (i.e., requested governance metadata 140).

At operation 309, the MGP 110, or a processor 125 accessing the governance metadata 140, may return (e.g., via one or more internal API calls or internal API responses) the requested governance metadata 140 and/or any other data that may be relevant and used to process the ingestion verification governance check 303A. For example, identification data, such as an identifier of the source 103 or an organization operating the source 103 and an identifier of the contract 116, may be returned with the requested governance metadata 140. The governance metadata 140 may be obtained as part of the governance check 303A, and the governance metadata 140 may correspond to or be based on data associated with the trigger event.

The governance application 111 may be programmed to avail of and/or access one or more rule bases 135 (e.g., rule-based logic or code) to perform the governance checks 303A on the data 220 based on the governance metadata 140 and one or more event parameters associated with the trigger event, and to obtain a governance parameter 315A. In some embodiments, the rule bases 135 may be specific to types of governance checks 303A. For example, each governance check 303A may include determining one or more applicable rule bases 135 with one or more rules or conditions, and the governance check 303A may succeed based on some combination of the rules or conditions from the rule bases 135 being satisfied. Each of the rule bases 135 may be associated with various input factors, such as, for example, at least one of a source 103 of the data 220, a type of the data 220, the event triggering performance of the governance check 303A, a client 106 requesting access to the data 220, a type of use for which the client 106 is requesting access to the data 220, downstream users of the data 220, geographical locations of the source 103 or the client 106, etc. The governance application 111 may perform the governance check 303A via a combination of one or more internal and/or external API calls, to determine an output governance parameter 315A, which may be a value or a parameter indicative of other operations that may be performed for the data 220. The governance parameter 315A may include information and/or instructions to perform a governance action at the MGP 110. For example, the parameter of the governance parameter 315A may indicate to store the data 130 at the MGP 110, prevent storage or further processing of the data 130 at the MGP 110 (i.e., not store the data 130 at the MGP 110), or archive the data 130 at the MGP 110.

For example, the rule bases 135 used for the ingestion verification governance check 303A may indicate the following rules for data 220 from a particular source 103: (1) the organization associated with the source 103 is to be a valid and active organization registered with the MGP 110, and (2) the contract 116 is to be valid (i.e., not expired) for the data 220 to be properly stored at the MGP 110. Based on the outcome of the governance check 303A (e.g. some logical combination of rule evaluations or conditions in rule bases 135), the governance parameters 315A may indicate whether or not the data 220 is suitable for storing at the MGP 110. For example, when the governance application 111 determines based on the governance metadata 140 that the contract 116 related to the data 220 is still valid and the source 103 of the data 220 is indeed a customer or user of the MGP 110, the governance parameter 315A may indicate that the data 220 may continue to be stored in the MGP 110. As such, the data 220 may continue to pass along the system governance pipeline 200. The governance parameter 315A may also include additional instructions. For example, if the governance application 111 determines based on the governance metadata 140 that the contract 116 related to the data 220 has expired, or that the source 103 of the data 220 is not actually a customer or user of the MGP 110, then, the governance parameter 315A may include instructions to prevent storage or further processing of the data 220. The governance parameter 315A indicative of the instructions may also be transmitted to source 103.

In some embodiments, the ingestion verification governance check 303A may verify governance metadata 140—an organization identifier, a contract identifier, and a contract expiration date—to permit data storage and processing of the source data 113 at the MGP 110. The governance application 111 may confirm that the organization associated with the source 103 is unique and active, and the governance application 111 may confirm whether the contract 116 governing the source data 113 is valid (e.g., the contract identifier is on file and that the contract has not expired). The relevant contract 116 here may be an agreement between the source 103 and the MGP 110, for example.

Referring now to FIG. 3B, shown is a sequence diagram 320 illustrating governance checks 303B, 303C, 303D performed in the processing and operations block 206. The governance checks 303B, 303C, 303D may be performed based in part on governance metadata 140 to generate an output governance parameter 315B, 315C, 315D, respectively. In some embodiments, governance checks 303B, 303C, 303D may be based on other governance metadata 140 and may generate different governance parameters 315B, 315C, 315D, respectively.

Governance check 303B (also referred to herein as the “data classification governance check 303B”) may be performed in response to an event. The event may occur, for example, when the data 220 is stored in the MGP 110, when the data 220 is processed, when the data 220 has been tagged as “confidential,” “restricted,” or “highly restricted”, etc. The data classification governance check 303B may also be performed periodically based on a preset schedule or in response to a request from a source 103 or a client 106. The data classification governance check 303B may ensure that the type of data 220 may be stored or continue to be stored at the MGP 110.

In some embodiments, to perform the data classification governance check 303B, the governance application 111 may obtain, for example, a restriction classification of the data 220 from the governance metadata 140. For example, the restriction classification may include categories such as “confidential,” “restricted,” or “highly restricted,” etc. as mentioned above. However, it should be appreciated that the restriction classification of the data 220 may be notated with the data 220 in many other ways, for example, using numerical values, based on the content of the data 220, etc. In some embodiments, at operation 323, the governance application 111 may transmit an (internal) governance metadata request for the restriction classification of the data 220 to the governance metadata 140. The governance metadata request may indicate the requested governance metadata 140 (i.e., the restriction classification of the data 220), one or more event parameters associated with the trigger event, and/or other data associated with data 220 or the trigger event. At operation 326, the MGP 110, or a processor 125 accessing the governance metadata 140, may return the requested governance metadata 140 and/or any other relevant data to the governance application 111.

In some cases, the governance application 111 may process the restriction classification of the data 220 using the rule bases 135 to govern access to the data 220 and storage of the data 220 at the MGP 110. In some embodiments, the governance application 111 may determine whether the MGP 110 may access the data 220 having the restriction classification based on the governance metadata 140, rule bases 135, and/or one or more event parameters associated with the trigger event, and output a governance parameter 315B accordingly. For example, the rule bases 135 for the data classification governance check 303B may include a rule indicating that data 130 of certain classifications may be stored at the MGP 110 and/or data 130 of certain classifications may not be stored at the MGP 110. If the MGP 110 may store the data 220 having the restriction classification, the governance parameter 315B may indicate that the data 220 can be stored (e.g. because storage is compliant with the restriction classification of the data 220 and applicable rules and guidelines governing the data 220). In some cases, the governance parameter 315B may include instructions to continue to pass the data 220 along the system governance pipeline 200. If the MGP 110 may not store the data 220 having the restriction classification, the governance parameter 315B may indicate this restriction and in some cases, may include instructions to prevent storage or further processing of the data 220. The governance application 111 may also transmit a notification indicative of the instructions in the governance parameter 315B to the source 103.

In some embodiments, governance check 303C (also referred to herein as the “source-related governance check 303C”) may be performed in response to an event. The event may occur, for example, when a request to store the data 220 is received from the source 103, a request (e.g., transfer request) to receive and store the data 220 from another geographical location is received, a request to load balance the data 220 from one geographical location to another geographical location is received, the data 220 being stored in the MGP 110, the data 220 being processed, etc.

In some embodiments, the source-related governance check 303C may also be performed periodically based on a preset schedule or in response to a trigger event. The source-related governance check 303C may ensure that the data 220 may continue to be stored at the repositories 122 of the MGP 110. For example, the source-related governance check 303C may ensure that the data 220 may be transferred from a current geographic location to a new location of the repositories 122 of the MGP 110 (or transferred from another geographic location to the current geographic location), based on a request to transfer the data 220, due to MGP guidelines (e.g. elapsed time), for load/resource balancing, and/or archival purposes.

To perform the source-related governance check 303C, the governance application 111 may determine governance metadata 140 (e.g., source-related parameters) based on an event parameter associated with the trigger event (e.g., the request received from the source 103, data carried in the request, etc.). For example, the governance application 111 may determine governance metadata 140 such as an identifier of the source 103, an address of the source 103, a location of the source 103, etc. based on the request received from the source 103. Accordingly, the term source 103 may refer not only to an entity (e.g. a hospital) requesting storage of MD at the MGP 110, but may also refer to another system external to the MGP 110, or a second repository 122-2 at a second/distinct geographical location within the MGP 110 requesting transfer of the data from a first repository 122-1 at a first location.

The governance application 111 may obtain both source and destination related rules and guidelines applicable to the data 220, which may be stored in the governance metadata 140 and used to govern the movement of the data 220. In some embodiments, at operation 329, the governance application 111 may transmit an (internal) governance metadata request for the source and destination related rules and guidelines applicable to the data 220 to the governance metadata 140. The governance metadata request may indicate the requested governance metadata 140 (i.e., the source-related rules and guidelines of the data 220), one or more event parameters associated with the trigger event, and/or other data associated with data 220. At operation 331, the MGP 110, or a processor 125 accessing the governance metadata 140, may return the requested governance metadata 140 and/or any other relevant data to the governance application 111.

In some cases, the governance application 111 may process the received and determined governance metadata 140 using the rule bases 135 to govern movement of the data 220. In some embodiments, the governance application 111 may determine whether the MGP 110 may store the data 220 or transfer in the data 220 based on the governance metadata 140, rule bases 135, and/or one or more event parameters associated with the trigger event (e.g., information in a received request). The rule bases 135 may include one or more rules indicating conditions for governing the movement of the data 220. For example, the rules may be related to a source 103 of the data 220 (e.g., whether the data 220 that is received from the source 103 may be stored (or continue to be stored) at a source repository 122-1 of the MGP 110), related to a destination of the data 220 (e.g., whether the data 220 may be transferred to the destination and stored at a separate destination repository 122-2 of the destination), related to the data 220 (e.g., whether the data 220 may be transferred/moved to the destination repository 122-2 or is to remain at the current repository 122-1), etc. For example, the rule base 131 for the source-related governance check 303C may include one or more conditions directed to verifying a source 104 of the data 220, verifying a source repository 122-1 of the data 220, verifying a destination repository 122-2 of the data 220 (e.g., destination of the data 220), and/or verifying transfer of the data 220 from the source repository 122-1 to the destination repository 122-2 (e.g., verifying that the data 220 may be transferred/moved to from the source repository 122-1 to the destination repository 122-2). In some embodiments, the rule bases 135 may be used to confirm whether the data 220 is, for example, contractually and/or legally permitted to be stored in a certain location, and/or whether there are any restrictions on the transfer and/or use of the data 220.

The governance application 111 may perform the source-related governance check 303C based on the governance metadata 140, one or more event parameters associated with the trigger event, and the rule bases 135 to output a governance parameter 315C accordingly. If the data 220 from the source 103 may be stored (or continue to be stored) at the destination repository 122-2, the governance parameter 315C may include a parameter indicating an instruction to store the data 220 at the destination repository 122-2 (e.g., transfer the data from the source repository 122-1 to the destination repository 122-2). The governance parameter 315 may also include instructions to continue to pass the data 220 along the system governance pipeline 200. In contrast, if the data 220 from the source 103 may not be stored at the destination repository 122-2, the governance parameter 315C may include a parameter with instructions to either retain the data 220 at the source repository 122-1, prevent transfer and storage of the data 220 to the destination repository 122-2, or prevent storage or further processor of the data 220 at both the source repository 122-1 and the destination repository 122-2. The governance application 111 may transmit a notification indicative of the instruction in the governance parameter 315C to the source 103.

In an embodiment, the trigger event is a transfer request for the data 220, and the governance metadata 140 is indicative of one or more destinations (e.g., repositories 122-1, 122-1 or other MGPs 110) at which the data 220 may be stored (e.g., permitted to be stored/not permitted to be stored). The governance metadata 140 may also indicate whether the data 220 is permitted to be moved or is to be retained within the original repository 122-1, 122-2. The governance application 111 may determine, based on the governance metadata 140, the governance parameter 315C by determining whether the event parameters of the transfer request (e.g., the data 220 requested to be moved and the requested destination) is consistent with the permissions indicated in the governance metadata 140 as part of an evaluation of the one or more conditions associated with the rule base 135.

For example, there may be countries and/or regions from which data 220 may not cross borders, which may be indicated in the governance metadata 140 and encoded in the rule bases 135. Similarly, access to data 220 by users outside of a specified hospital, city, country or region may be governed based on various rules and guidelines, which may be indicated in the governance metadata 140 and encoded in the rule bases 135. The source-related governance check 303C may govern the transfer and storage of the data 220 being received from another entity and/or another geographical location, or requested to be sent to another entity and/or geographical location, based on the governance metadata 140 and the applicable rule bases 135.

In some embodiments, governance check 303D (also referred to herein as the “retention schedule governance check 303D”) may be based on a retention schedule associated with the data 220. A retention schedule may refer to a predefined policy or plan outlining various retention factors and rules related to the retention and disposition of data 220 managed at the MGP 110. A retention schedule may indicate a lifecycle of the data 220, a duration of storing the data at the MGP 110, times, conditions, or events triggering the archiving or deleting the data 220, etc. For example, the conditions for archiving or deleting the data 220 may be associated with a termination of a contract 116 between the source 103 of the data 220 and the MGP 110, a retention date associated with the contract, a retention law or regulation, or based on a request to remove or archive data 220 from the MGP 110 (e.g. for resource utilization purposes).

The retention schedule governance check 303D may be performed in response to an event-including time-related events or an elapsed time (e.g., predefined amount of time elapsed). The event may occur, for example, when the data 220 is stored in the MGP 110, when the data 220 is being processed, when the retention schedule for the data 220 is received, when a request to access the data 220 from a client 106 is received, elapsed time from another event (e.g. date the data 220 was first received/stored), etc. The retention schedule governance check 303D may also be performed periodically based on a preset schedule or in response to a request to perform the governance check 303D. The retention schedule governance check 303D may ensure that the data 220 may continue to be stored at the MGP 110 based on a lifecycle of the data 220 indicated in the retention schedule of the data 220

To perform the retention schedule governance check 303D, the governance application 111 may determine a retention schedule of the data 220, which may be indicated in the governance metadata 140. The retention schedule of the data 220 may be obtained based on various factors, such as, for example, a contract 116, regulations or laws, and even usage of the data 220. For example, the retention schedule may be associated with a World Wide Records Information Management Retention Schedule, which may be accessible by the governance application 111. A retention period for data 220 may vary by use of the data 220 (e.g., regulatory submissions or general research). At operation 333, the governance application 111 may transmit an (internal) governance metadata request for the retention schedule of the data 220 to the governance metadata 140. The governance metadata request may indicate the requested governance metadata 140 (i.e., the retention schedule of the data 220), one or more event parameters associated with the trigger event, and/or other data associated with the data 220. At operation 335, the MGP, or a processor 125 accessing the governance metadata 140, may return the requested governance metadata 140 and/or any other relevant data to the governance application 111.

In some cases, the governance application 111 may process the retention schedule of the data 220 using the rule bases 135 to govern retention of the data 220 at the MGP 110. In some embodiments, the governance application 111 may determine whether the MGP 110 may continue storing the data 220 having the retention schedule and output a governance parameter 315D based on the governance metadata 140, rule bases 135, and/or one or more event parameters associated with a trigger event (e.g., a time-based event). For example, a rule bases 135 for the retention schedule governance check 303D may include a rule indicating that data 220 is to be archived based on certain types of laws and regulations, and/or a rule indicating that data 220 is to be discarded from the MGP 110 after a certain period of time indicated in the retention schedule of the data 220. If the MGP 110 may continue storing the data 220 having the retention schedule, the governance parameter 315D may include instructions to continue to pass the data 220 along the system governance pipeline 200. If the MGP 110 may not continue storing the data 220 having the retention schedule, the governance parameter 315D may include instructions to either archive, discard, or prevent storage and/or further processing of the data 220. The governance application 111 may also transmit a notification indicative of the instructions in the governance parameter 315D to the source 103.

In an embodiment, the trigger event may be elapsed time, and the governance metadata 140 may be a retention schedule for the data 220. The governance application 111 may determine, based on the governance metadata 140, the governance parameter 315D by determining a retention-related action that is consistent with the retention schedule as part of an evaluation of one or more conditions associated with the rule base 135. For example, the rule base 135 may include one or more retention policies for the data 220, in which the retention policies may indicate one or more conditions, which when met, indicates that a retention-related action is to be performed on the data 220. The retention policies may also indicate one or more retention parameters related to the retention-related action. The retention-related action may be, for example, maintaining existing retention of the data 220, deleting the data 220, or archiving the data 220 based on archiving parameters indicated in a retention policy. The governance parameter 315D may be indicative of the retention-related action, if the retention-related action may be performed for the data 220.

In an embodiment, governance parameters 315B, 315C, 315D may be output as a single governance parameter 315B, 315C, 315D, respectively (as opposed to three separate governance parameters 315B, 315C, 315D). The single governance parameter 315B, 315C, 315D, may indicate one or more governance actions (e.g., instruction(s) to perform an action) or recommendations. In some cases, not all of the governance actions may have to be performed. For example, if one governance action indicates that the data 220 is to be deleted from the MGP 110, another governance action indicating that the data 220 should be relocated may be considered moot.

While FIG. 3B only shows the three governance checks 303B, 303C, and 303D performed in the processing and operations block 206, it should be appreciated that any number of governance checks 303B, 303C, 303D and any type of governance check 303B, 303C, 303D may be performed in the processing and operations block 206. For example, governance checks related to a first purpose or use of the data 220, the validity of the contract 116, etc. may also be performed in the processing and operations block. Moreover, it should be appreciated that not all of the governance checks 303B, 303C, and 303D may be performed, and that the performed governance checks 303B, 303C, and 303D may be performed in any order (i.e., not necessarily in the order shown in FIG. 3B).

Referring now to FIG. 3C, shown is a sequence diagram 340 illustrating a governance check 303E. While FIG. 3C illustrates that governance check 303E is performed in the processing and operations block 206, in some cases, the governance check 303E may be distributed between the processing and operations block 206 and the analytical block 209. In particular, the governance check 303E may be performed before any secondary use is performed using the data 220.

Governance check 303E (also referred to herein as the “secondary use governance check 303E”) may be performed in response to an event. The event may occur, for example, when the data 220 is stored in the MGP 110, when a request (e.g., access request) to access the data 220 from a client 106 is received, a time-based event, etc. The secondary use governance check 303E may also be performed periodically based on a preset schedule, for example, when the data 220 has not yet been transformed into secondary use data 133 (i.e., lower risk data). The secondary use governance check 303E may ensure that the data 220 may be (1) accessed for secondary use (e.g., other than the first purpose), (2) used by a particular client 106, and (3) for a requested secondary purpose. For example, the governance metadata 140 may indicate secondary use conditions, such as whether data 220 may be accessed for secondary use, the types of sources 103/clients 106 or identifiers of sources 103/clients 106 that are may access the data 220 for secondary use, the types of uses (e.g., analytical, research, advertisement, machine maintenance, clinical, etc.) that are secondary purpose types of uses for which the data 220 may or may not be accessed, etc.

To perform the secondary use governance check 303E, the governance application 111 may obtain the foregoing secondary use conditions of the data 220 from the governance metadata 140 based on one or more event parameters of the trigger event (e.g., the request for secondary use from a client 106). For example, at operation 342, the governance application 111 may determine data identifying the client 106 and/or a location of the client 106, and the governance application 111 may also transmit an (internal) governance metadata request for the governance metadata 140 (e.g., the secondary use conditions of the data 220) from the governance metadata 140. The governance metadata request may indicate the requested governance metadata 140 (i.e., the secondary use conditions of the data 220), one or more event parameters associated with the trigger event, and/or other data associated with the data 220. At operation 344, the governance metadata 140, or a processor 125 accessing the governance metadata 140, may return the requested governance metadata 140 and/or any other relevant data to the governance application 111.

In some cases, the governance application 111 may evaluate the secondary use conditions of the data 220 using the rule bases 135 to govern access to the data 220 for secondary use. In some embodiments, the governance application 111 may determine whether the MGP 110 may provide secondary use access for the data 220 based on the rule bases 135, one or more parameters associated with the trigger event (e.g., the request from the client 106), and/or the governance metadata 140, and output a governance parameter 315E accordingly. For example, a rule bases 135 for the secondary use governance check 303E may include one or more rules to confirm values for a secondary use permission flag and/or a secondary use purpose, both of which may be obtained from the governance metadata 140, and both of which may be processed and analyzed for secondary use purposes. For example, the rule bases 135 may include a first rule to verify that the permitted secondary use flag includes a value indicating that secondary use may be permitted for the data 220, and if yes, then proceed to a second rule indicating permitted secondary use categories for the data 220 (e.g., which may be obtained from the governance metadata 140). One or more applicable contracts 116 may drive a determination regarding the processing and analysis of data 220 outside of the first purpose indicated in the contract 116 (e.g., which may be an intended purpose of the data 220). The governance of the data 220 for secondary purposes other than the first purpose may be driven by the contracts 116.

If the MGP 110 may provide access to the data 220 for secondary use, the governance application 111 may again process the secondary use conditions of the data 220 using the rule bases 135 to determine whether the MGP 110 may provide the requesting client 106 access to the data 220 for a type of secondary use, and thus, output another governance parameter 315E accordingly. If the MGP 110 may not provide secondary use access to the data 220 and/or to the requesting client 106, the governance parameter 315E may include instructions to deny the client 106 access to the data 220. The governance application 111 may also transmit a notification indicating a denial of the request to the requesting client 106.

In some embodiments, the governance check 303E may function to filter all secondary use requests from clients 106 through a multi-tiered security clearance and filtering process (i.e., determine a governance for the secondary use requests for the data 220, and determine governance for a particular type of use of the data 220 by the requesting client 106). When the secondary use flag indicates that the data 220 may be used by certain clients 106 for the contracted-for purpose and not by other clients 106 for secondary use purposes, the governance application 111 may prevent this data 220 from being transformed using one or more de-identification processes. By preventing potentially large amounts of data 220 from unnecessarily being anonymized or de-identified, the governance application 111 saves the computing resources that would have otherwise been consumed with the computationally heavy de-identification processes. This may also prevent a non-compliant processing activity against a data asset governed under a contract 116. This also saves networking resources by preventing the data 130 from being converted into secondary use data 133, which is often transferred to one or more different logical or physical locations in the MGP 110 (to prevent comingling of de-identified data and data containing personally identifying information). The de-identified secondary use data 133 is sometimes redundant in content, even though the secondary use data 133 is de-identified. In some cases, if it is determined that no data 220 or portion of the data 220 is to be transferred, then the resources (e.g., network traffic, storage, compute, and other resources) may be better utilized. Therefore, by preventing the redundant conversion and storage of the secondary use data 133, the governance application 111 saves an enormous amount of memory at the MGP 110 as well. Nevertheless, the governance application 111 may still determine that data 220 may be accessed for secondary use, and in these cases the data 220 may be passed through the system governance pipeline 200, for example, into the de-identification block 212.

In an embodiment, the trigger event is an access request to the data 220 for a specified purpose (e.g., first purpose or a secondary purpose), and the governance metadata 140 for the data 220 may indicate the first purpose for usage/access of the data 220. The governance application may determine whether the specified purpose from the access request is consistent with the first purpose in the governance metadata 140 as part of an evaluation of the one or more conditions associated with the rule base 135. For example, the rule base 135 may include a condition indicating that the access request may be granted when the specified purpose is consistent with the first purpose, and/or may include a condition indicating that the access request may be denied when the specified purpose is not consistent with the first purpose. The governance application 111 may determine the governance parameter 315E as part of an evaluation of one or more conditions associated with the rule base 135, based on a determination of whether the specified purpose is consistent with the first purpose. The governance application 111 may set up the governance parameter 315E to indicate enablement of the access request for the specified purpose when the specified purpose is consistent with the first purpose. The governance application 111 may set up the governance parameter 315E to deny the access request for the specified purpose when the specified purpose is not consistent with the first purpose.

Referring now to FIG. 3D, shown is a sequence diagram 345 illustrating a governance check 303F, which may be performed on data 220 in the de-identification block 212. In some embodiments, governance check 303F may be performed in or distributed between the processing and operations block 206 or in the analytical block 209. Governance check 303F (also referred to herein as the “de-identification governance check 303F”) may be performed in response to an event. The event may occur, for example, when the data 220 is stored in the MGP 110, the data 220 is being processed, upon receiving a request to access the data 220 from a client 106, upon determining that the data 220 is higher risk and should be de-identified, a time-based event, etc. The de-identification governance check 303F may also be performed periodically on the secondary use data 133 based on a preset schedule, for example, to ensure that the risk of re-identification of the secondary use data 133 (e.g., a risk score) continues to fall below any pre-defined or updated thresholds. The de-identification governance check 303F may ensure that the data 220 has been de-identified according to de-identification parameters indicated in the governance metadata 140, which may include, for example, the standard/algorithm or pre-defined threshold risk score associated with a baseline risk of re-identification that should be used to de-identify the data 220 and other de-identification standards associated with retaining the data 220 at the MGP 110. For example, the de-identification governance check 303F may be used to confirm a data de-identification status of the data 220, the risk score of the data 220, and to determine if and how to initiate a de-identification process on the data 220 when de-identification is to be performed on the data 220.

To perform the de-identification governance check 303F, the governance application 111 may determine the de-identification parameters of the data 220 indicated in the governance metadata 140. For example, at operation 347, the governance application 111 may transmit an (internal) governance metadata request for the de-identification parameters of the data 220 to the governance metadata 140. The governance metadata request may indicate the requested governance metadata 140 (i.e., the de-identification parameters of the data 220), one or more parameters associated with the trigger event, and/or, other data associated with the data 220. At operation 349, the governance metadata 140, or a processor 125 accessing the governance metadata 140, may return the requested governance metadata 140 and/or any other relevant data to the governance application 111.

In some cases, the governance application 111 may also determine whether data 220 is compliant with de-identification standards after using the rule bases 135 to de-identify the data in accordance with the de-identification standards associated with the MGP 110. In some embodiments, the governance application 111 may then output a governance parameter 315F based on the results of the determination, the governance metadata 140, the rule bases 135, and/or one or more event parameters associated with the trigger event. For example, the rule bases 135 may indicate that certain types of data 220 are to be de-identified based on certain types of de-identification methods and/or standards, which may be indicated in the governance metadata 140. If the data 220 has been de-identified according to the de-identification methods and/or standards by the MGP 110, the governance parameter 315F may indicate that the secondary use data 133 may be stored for secondary use, and in some cases, may include instructions to continue to pass the data 220 along the system governance pipeline 200. If the data 220 has not been de-identified according to the de-identification methods and/or standards by the MGP 110, the governance parameter 315F may indicate that the secondary use data 133 may not continue to be stored for secondary use. In some cases, the governance parameter 315F may include instructions to prevent storage or further processing of the data 220 and may transmit a notification indicative of the instructions in the governance parameter 315F to the source 103. The governance parameter 315F may include instructions to de-identify the data 220 according to the de-identification parameters in the governance metadata 140 (to properly generate the secondary use data 133).

Referring now to FIG. 3E, shown is a sequence diagram 360 illustrating governance checks 303G and 303 H, which may be performed on data 220 in the processing and operations block 206 or the analytical block 209. Governance check 303G (also referred to herein as the “data quality governance check 303G”) may be performed in response to an event. The event may occur when, for example, the data 220 is being stored in the MGP 110, the data 220 is being processed, receiving a request to access the data 220 from a client 106, updates or changes to data quality parameters associated with the data 220, a time-based event, etc. The data quality governance check 303G may also be performed periodically based on a preset schedule or in response to a request to perform the governance check 303G. The data quality governance check 303G may ensure that the data 220 has been transformed according to data quality parameters indicated in the governance metadata 140, and the data quality parameters may include, for example, the standards for completeness, format, corruption, field/schema accuracy, etc.

To perform the data quality governance check 303G, the governance application 111 may determine the data quality parameters of the data 220 indicated in the governance metadata 140. In some embodiments, at operation 362, the governance application 111 may transmit an (internal) governance metadata request for the data quality parameters of the data 220 to the governance metadata 140. The governance metadata request may indicate the requested governance metadata 140 (i.e., the data quality parameters of the data 220), one or more event parameters associated with the trigger event, and/or other data associated with the data 220. At operation 364, the governance metadata 140, or a processor 125 accessing the governance metadata 140, may return the requested governance metadata 140 and/or any other relevant data to the governance application 111.

In some cases, the governance application 111 may process the data quality parameters of the data 220 using the rule bases 135 to govern the management of the data 220 at the MGP 110. In some embodiments, the governance application 111 may determine whether the quality of the data 220 meets (or is consistent with) the standards indicated in the data quality parameters based on the governance metadata 140, the rule bases 135, and/or one or more event parameters associated with the trigger event, and output a governance parameter 315G accordingly. For example, the rule bases 135 for the data quality governance check 303G may indicate one or more rules governing the data quality parameters or standards that the data 220 is to meet to be stored and governed by the MGP 110, and the data quality parameters or standards may be indicated in the governance metadata 140. A condition of the rule bases 135 may include verifying that a quality of the data 220 is consistent with the data quality parameters or standards. If the quality of the data 220 is consistent with the standards indicated in the data quality parameters, the governance parameter 315G may indicate that the data 220 may continue to be stored at the MGP 110. In some cases, the governance parameter 315G may include instructions to continue to pass the data 220 along the system governance pipeline 200. If the quality of the data 220 is not consistent with or does not meet the standards indicated in the data quality parameters, the governance parameter 315G may indicate that the data 220 may not continue be stored at the MGP 110. In some cases, the governance parameter 315G may include instructions to prevent storage of or further processing of the data 220. The governance application 111 may also transmit a notification indicative of the instructions in the governance parameter 315G to the source 103. The governance parameter 315G may also include instructions to transform/process the data 220 such that the quality of the data 220 after transforming/processing meets the standards indicated in the data quality parameters.

Governance check 303H (also referred to herein as the “data bias governance check 303H”) may be performed in response to an event. For example, the event may occur upon the data 220 being stored in the MGP 110, upon the data 220 being processed, or upon receiving a request to use the data 220 from a client 106 for artificial intelligence purposes, a time-based event, etc. The data bias governance check 303H may also be performed periodically based on a preset schedule or in response to a request to perform the governance check 303H. The data bias governance check 303H may check for the statistical bias of the data 220 based on various factors such as collection methodology, population demographics, etc. For example, the data bias governance check 303H may be used to track data types that are used as training data, to have knowledge of the source and cohort for downstream data use, and to minimize risks associated with data bias. In this way, the data bias governance check 303H may ensure that the data 220 has been transformed according to data bias parameters and data bias guidelines established by a governance authority associated with the MGP 120. The data bias parameters may be indicated in the governance metadata 140, and the data bias parameters may indicate different statistical biases, data types permitted to be used as training data in artificial intelligence models, conditions regarding the sources 103 or the cohorts using the data 220 for artificial intelligence model generation, etc.

To perform the data bias governance check 303H, the governance application 111 may determine the data bias parameters of the data 220 indicated in the governance metadata 140. For example, at operation 366, the governance application 111 may transmit an (internal) governance metadata request for the data bias parameters of the data 220 to the governance metadata 140. The governance metadata request may indicate the requested governance metadata 140 (i.e., the data bias parameters of the data 220), one or more event parameters associated with the trigger event, and/or other data associated with the data 220. At operation 368, the governance metadata 140, or a processor 125 accessing the governance metadata 140, may return the requested governance metadata 140 and/or any other relevant data to the governance application 111.

In some cases, the governance application 111 may process the data bias parameters of the data 220 using the rule bases 135 to govern the management and storage of the data 220 at the MGP 110. In some embodiments, the governance application 111 may determine whether the data 220 meets (or is consistent with) the standards indicated in the data bias parameters based on the governance metadata 140, the rule bases 135, and/or one or more parameters associated with the trigger event, and output a governance parameter 315H accordingly. For example, the rule bases 135 for the data bias governance check 303H may indicate one or more rules governing the data bias parameters that the data 220 is to meet to be stored, managed, and governed by the MGP 110, and the data bias parameters may be indicated in the governance metadata 140. If the data 220 meets the standards indicated in the data bias parameters, the governance parameter 315H may indicate that the data 220 may continue to be stored at the MGP 110. In some cases, the governance parameter 315H may include instructions to continue to pass the data 220 along the system governance pipeline 200. If the data 220 does not meet the standards indicated in the data bias parameters, the governance parameter 315H may indicate that the data 220 may not continue to be stored at the MGP 110. The governance parameter 315H may include instructions to prevent storage or further processing of the data 220 and a notification indicative of the instructions in the governance parameter 315H may be transmitted to the source 103. The governance parameter 315H may also include instructions to transform/process the data 220 such that the quality of the data 220 after transforming/processing meets the standards indicated in the data bias parameters.

Referring now to FIG. 3F, shown is a sequence diagram 375 illustrating governance checks 303I, 303J, 303K, which may be performed on data 220 in the analytical block 209. Governance check 303I (also referred to herein as the “client governance check 303I”) may be performed in response to an event. The event may occur, for example, when a request is received from a client 106 to process data 220, a time-based event, etc. The client governance check 303I may ensure that the client 106 is contractually authorized to access the data 130 for the first purpose and/or access the secondary use data 133 for a secondary purpose, based for example, on contractual terms and provisions indicated in the governance metadata 140. The client governance check 303I may also use various contract terms and provisions (e.g., an organization identifier, contract identifier, and contract expiration data) to determine whether a client 106 is authorized to process data 220 in the analytical block 209.

To perform the client governance check 303I, the governance application 111 may determine governance metadata 140 (e.g., client-related parameters) based on, for example, the request for use of the data 130 and/or secondary use data 133 received from the client 106. For example, the governance application 111 may determine governance metadata 140 such as an identifier of the client 106, an address of the client 106, a location of the client 106 based on the request received from the client 106. The governance application 111 may also obtain the contractual terms and provisions related to the processing of the data 220 indicated in the governance metadata 140. For example, at operation 377, the governance application 111 may transmit an (internal) governance metadata request for the contractual terms and provisions related to the processing of the data 220 to the governance metadata 140. The requested contractual terms and provisions may include, for example, the organization identifier, contract identifier, and contract expiration data. The governance metadata request may indicate the requested governance metadata 140 (i.e., the contractual terms and provisions related to the processing of the data 220), one or more event parameters associated with the trigger event, and/or other data associated with the data 220 and/or the client 106. At operation 379, the governance metadata 140, or a processor 125 accessing the governance metadata 140, may return the requested governance metadata 140 and/or any other relevant data to the governance application 111.

In some cases, the governance application 111 may process the contractual terms and provisions related to the processing of the data 220 using the rule bases 135 to govern whether certain clients 106 may access the data 220. In some embodiments, the governance application 111 may determine whether the client 106 may receive access to the data 220 based on the governance metadata 140, the rule bases 135, and/or one or more event parameters associated with the trigger event, and output a governance parameter 315I accordingly. For example, a rule bases 135 for the client governance check 303I may include a first rule to verify an organization identifier associated with the client 106 (e.g., verify that the organization is a user or customer of the MGP 110), a contract identifier identifying a contract 116 between the client 106 and the MGP 110 (or the source 103 of the data 220 and the MGP 110), and/or a contract expiration date of the aforementioned contracts (e.g., whether the contract is still valid or is expired). If the requesting client 106 may access the data 220 based on the rule bases 135, the governance parameter 315I may include instructions to permit the client 106 to access the data 220. If the requesting client 106 may not access the data 220, the governance parameter 315I may instructions to reject the request from the client 106 to process the secondary use data 133. The governance application 111 may transmit, to the client 106, a notification regarding the instructions included in the governance parameter 315I.

In some embodiments, governance check 303J (also referred to herein as the “location-based governance check 303J”) may be performed based on an event. The event may occur, for example, when a request from a client 106 to access data 220 is received, a request to transfer data 220 to another geographical location is received, attempts to load or resource balance by transferring the data 220 from a first geographical location to second geographical location is received, a request to transfer secondary use data 133 to a geographical location to create analytical dashboards or analytical data is received, time-based events, etc. The location-based governance check 303J may ensure that the data 220 may be accessed by a client 106 at a particular location (e.g., geographic location) or zone (e.g., in a hospital) or may be transferred to another geographic location, or destination repository 122-2, for the purpose of analytical use based on the parameters indicated in the governance metadata 140.

To perform the location-based governance check 303J, the governance application 111 may determine governance metadata 140 (e.g., client-related parameters) based on, for example, an (external) data access request received from the client 106. For example, the governance application 111 may determine governance metadata 140 such as an identifier of the client 106, an address of the client 106, a location of the client 106, etc. based on the request received from the client 106. In some embodiments, the term client 106 may also refer to another system external to the MGP 110, or another repository 122-2 at another geographical location within the MGP 110.

The governance application 111 may then obtain client-related and location-based rules and guidelines applicable to the data 220, which may be stored in the governance metadata 140. The governance metadata 140 may include, for example, the locations (e.g., countries, regions, zones, buildings, etc.) of clients 106 that may or may not access the data 220, the locations of external systems or different repositories 122-2 that may or may not access the data 220, the secondary use geographical provisions indicating locations that may or may not be related to the access of the secondary use data 133 for secondary purposes, etc. For example, at operation 381, the governance application 111 may transmit an (internal) governance metadata request for the location-based rules and guidelines to the governance metadata 140. The governance metadata request may indicate the requested governance metadata 140 (i.e., the location-based rules and guidelines of the data 220), one or more event parameters associated with the trigger event, and/or other data associated with the data 220 and/or the client 106. At operation 383, the governance metadata 140, or a processor 125 accessing the governance metadata 140, may return the requested governance metadata 140 and/or any other relevant data to the governance application 111.

In some cases, the governance application 111 may process the location-based rules and guidelines using the rule bases 135 to govern the access, storage, retention, and transfer of the data 220. In some embodiments, the governance application 111 may determine whether the data 220 may be accessed by a client 106 or may be transferred to another geographic location for the purpose of analytical use based on the governance metadata 140, the rule bases 135, and/or one or more event parameters associated with the trigger event, and output a governance parameter 315J accordingly. For example, the rule bases 135 for the location-based governance check 303J may include one or more rules based on locations that may be regulated from data access or data transfers. For example, the rule bases 135 may include conditions related to clients 106 located in particular geographic zones or areas (e.g., the client 106 may or may not receive access to the data 220), or the rule bases 135 may include conditions related to external repositories 122-2 located in particular geographic zones or areas (e.g., the data 220 may not be transferred to or stored at the external repositories 122-2 in the zones or areas). If the data 220 may be access and/or transferred to a second geographic location for the purpose of analytical use, the governance parameter 315J may include instructions to permit the access or transfer of the data 122-2 for the client 106 or by the external repository 122-2 at the second geographic location. If the data 220 may not be accessed or transferred at the second geographic location for the purpose of analytical use, the governance parameter 315J may include instructions to reject the request from the client 106 or the external repository 122-2, and notify the client 106 or the external repository 122-2 regarding the instructions in the governance parameter 315J.

For example, the location-based governance check 303J may verify a location of a client 106 requesting access to data 220. The location-based governance check 303J may verify location of a destination server or repository 122. The locations may be verified against locations indicated in the governance metadata 140 and/or the rule bases 135, for example, to check for restrictions on access by clients 106 outside a specific hosting region.

Governance check 303K (also referred to herein as the “data disposal governance check 303K”) may be performed based on an event. The event may occur, for example, based on the retention schedule for the data 220, in response to receiving a request from the source 103 to delete the data 220, in response to determining that the data 220 should be archived, a time-based event, etc. The data disposal governance check 303K may also be performed periodically based on a preset schedule to validate the storage of the data 220 with respect to the retention schedule, or in response to a request to perform the governance check 303K. The data disposal governance check 303K may archive or dispose of the data 220 based on data disposal and archival parameters (e.g., as prescribed in organizational policies, contracts, industry standards, regulations, etc.) governing a time to and a method to archive or dispose of the data 220. The data disposal governance check 303K may archive or delete the data 220 for various reasons (e.g., malfunctioning of the machine being described by the data 220, the data 220 being related to a litigation, etc.).

To perform the data disposal governance check 303K, the governance application 111 may determine the data disposal and archival parameters of the data 220 indicated in the governance metadata 140. For example, at operation 387, the governance application 111 may transmit an (internal) governance metadata request for the data disposal and archival parameters of the data 220 to the governance metadata 140. The governance metadata request may indicate the requested governance metadata 140 (i.e., the data disposal and archival parameters of the data 220), one or more event parameters associated with the trigger event, and/or other data associated with the data 220. At operation 389, the governance metadata 140, or a processor 125 accessing the governance metadata 140, may return the requested governance metadata 140 and/or any other relevant data to the governance application 111.

In some cases, the governance application 111 may process the data disposal and archival parameters of the data 220 using the rule bases 135 to govern the disposal and archival of the data 220 at the MGP 110. In some embodiments, the governance application 111 may determine whether the data 220 may be stored (or continue to be stored) at the MGP 110 based on the governance metadata 140, the rule bases 135, and/or one or more event parameters associated with the trigger event, and output a governance parameter 315K accordingly. For example, the rule bases 135 may include one or more rules instructing the archival or discarding of data based on a final disposition of data assets hosted on the MGP 110, which may be indicated in the governance metadata 140, one or more rules related to a final phase of a data lifecycle or retention schedule, and/or one or more rules related to a use of the data 220 and/or a category of the data 220. The rule bases 135 may also include one or more rules related to the retention, destruction, or archival of the data 220 based on provisions and terms in applicable contracts 116. For example, the rule bases 135 may include a condition for verifying whether a contractual provision applicable to the data 220 indicates that the data is to be discarded or archived after a certain period of time, or the rule bases 135 may include a condition for verifying whether an organizational policy applicable to the data 220 indicates that the data is to be discarded or archived in response to an event. If the data 220 may continue be stored at the MGP 110, the governance parameter 315K may include instructions to continue to pass the data 220 along the system governance pipeline 200. If the data 220 may not continue be stored at the MGP 110, and instead should be discarded or archived, the governance parameter 315K may include instructions to discard or archive the data 220. When the governance parameter 315K indicates that the data 220 is to be discarded or archived, a rule base 135 may also indicate that the final data asset disposition may be recorded and communicated back to the source 103 per the contract 116 provisions. The governance parameter 315K may also include instructions to record the discarding and/or archiving of the data 220, and information describing the discarding and/or archiving of the data 220 may be transmitted to the source 103 of the data 220.

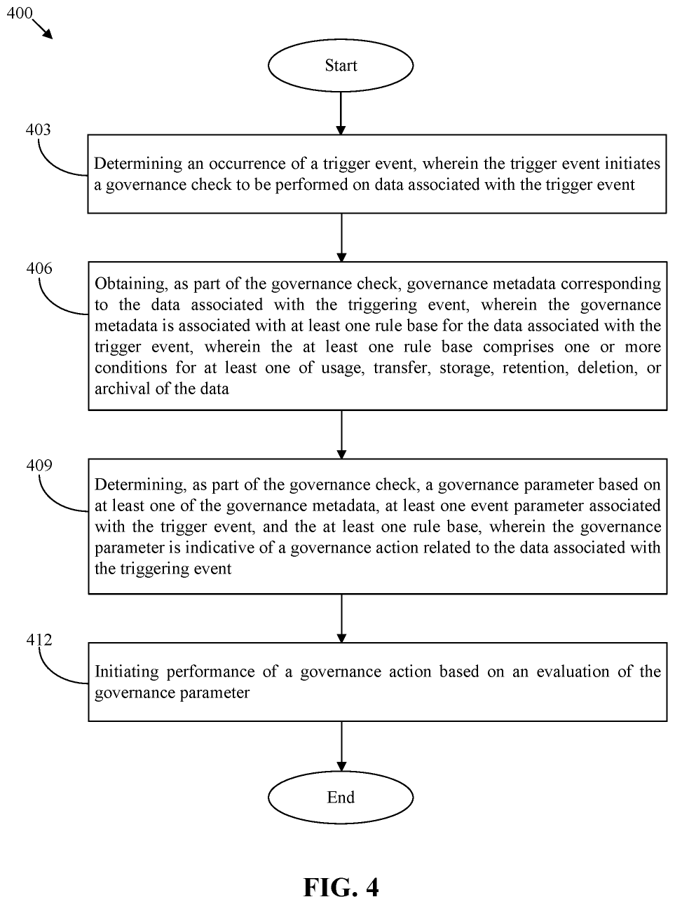

Turning now to FIG. 4, shown is a flowchart illustrating a method 400 for performing governance checks (e.g. governance checks 303A, 303B, 303C, 303D, 303E, 303F, 303G, 303H, 303I, 303J, 303K) (hereinafter referred to as “governance check 303”) to obtain a governance parameter (e.g. governance parameters 315A, 315B, 315C, 315D, 315E, 315F, 315G, 315H, 315I, 315J, 315K) (hereinafter referred to as “governance parameter 315”) at a MGP 110 according to various embodiments of the disclosure. In an embodiment, method 400 may be performed after a source 103 has transmitted source data 113 to the MGP 110. In some embodiments, method 400 may operate at least partially on data 220, which may include one or more of the source data 113, data 130, secondary use data 133, or any other form of data governed by the MGP 110. As illustrated, FIG. 4 includes a number of enumerated operations, but embodiments of the operations in FIG. 4 may include additional operations before, after, and in between the enumerated operations. In some embodiments, one or more of the enumerated operations may be omitted or performed in a different order.

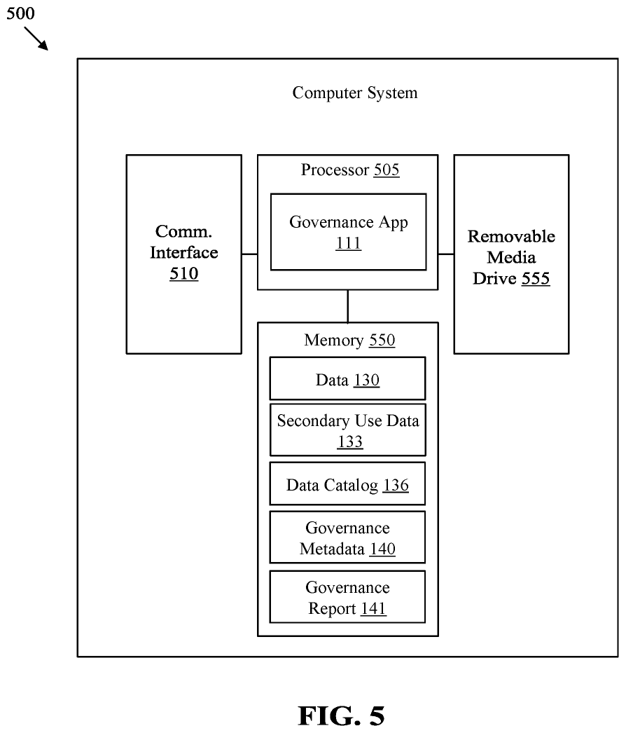

In an embodiment, method 400 may be performed by the governance application 111. As mentioned above, the governance application 111 may be provisioned at the MGP 110, such that the governance application 111 may perform the steps of method 400 using the hardware and software resources at the MGP 110. In another case, the governance application 111 may be implemented as a computer system, such as the computer system 500 shown in FIG. 5 and further described below. The computer system 500 may implement the governance application 111, such that the hardware and software resources of the computer system 500 perform the steps of method 400.

At step 403, method 400 may comprise determining an occurrence of a trigger event, wherein the trigger event initiates a governance check 303 to be performed on data 220 associated with the trigger event. In an embodiment, the trigger event is a request related to the data 220 associated with the trigger event. In an embodiment, the trigger event may be based on at least one of a timing indicated in a preset schedule, a request received from a source 103 to store the data 220 at the MGP 110, a request received from a client 106 to access the data 220 at the MGP 110, a request to perform a governance check 303 with respect to the data 220 at the MGP 110, a request to transfer the data 220 to a destination repository 122-2 at a separate location from a source repository 122-2, a request to delete or archive the data 220, a retention schedule associated with the data 220, a tagging of the data 220, a de-identification status of the data, or a quality of the data 220.

At step 406, method 400 may comprise obtaining, as part of the governance check 303, governance metadata 140 corresponding to the data 220 associated with the trigger event. In an embodiment, obtaining the governance metadata 140 may further comprise determining the at least one rule base 135 based on the at least one event parameter, the at least one event parameter being based on at least one of a source associated with the request, a type of the request, a destination association with the data, source data associated with the source of the request, or requested data specified as part of the request. The method may further comprise applying at least one of the governance metadata 140 or the event parameter associated with the trigger event to the at least one rule base 135 to obtain the governance parameter 315.

The governance metadata 140 is associated with at least one rule base 135 for the data 220 associated with the trigger event. The at least one rule base 135 comprises one or more conditions for at least one of usage, transfer, storage, retention, deletion, or archival of the data 220. In an embodiment, the at least one rule base 135 is determined based on at least one of a contractual provision, government regulation, or organizational policy applicable to at least one of a usage of the data 220, a transfer of the data 220, a storage of the data 220, a retention of the data 220, a deletion of the data 220, or an archival of the data 220. In an embodiment, obtaining the governance metadata 140 comprises applying natural language processing (NLP) to one or more documents that include one or more of the contractual provisions, governmental regulations, or organizational policies to obtain the governance metadata 140.

In an embodiment, the at least one rule base 135 comprises a first condition and a second condition. The first condition comprises verifying that a secondary use flag of the data 220 stored at the MGP 110 is set to a predefined value, and the second condition comprises verifying a secondary use requested by the client 106 for the data 220. In an embodiment, at least one rule base 135 comprises at least one of verifying a source 103 of the data 220, verifying the destination repository 122-2 of the data 220, or verifying transfer of the data 220 from the source repository 122-1 to the destination repository 122-2, and the governance parameter 315 comprises an instruction to initiate transfer of the data 220 from the source repository 122-1 to the destination repository 122-2.

At step 409, method 400 may comprise determining, as part of the governance check 303, a governance parameter 315 based on at least one of the governance metadata 140, at least one event parameter associated with the trigger event, and the at least one rule base 135. The governance parameter 315 is indicative of a governance action related to the data 220 associated with the trigger event. In an embodiment, the governance parameter 315 may comprise instructions to perform a governance action based on an evaluation of the governance parameter 315. At step 412, method 400 may comprise initiating performance of a governance action based on an evaluation of the governance parameter 315.

In an embodiment, the governance check 303 performed in method 400 may be the ingestion and verification governance check 303A. The trigger event comprises a request 103 to store requested data 150 (also referred to as source data) at the MGP 110, the governance metadata 140 comprises at least one of an organization identifier, a contract identifier, or a contract expiration date, and the governance parameter 315 is indicative of the governance action. The governance action may comprise one of storing the requested data 150 at the MGP 110 or rejecting the request to store the requested data 150 at the MGP 110.

In an embodiment, the governance check 303 performed in method 400 may be the secondary use governance check 303E. The trigger event comprises an access request received from a client 106 to access the data 220 for a specified purpose (e.g., a secondary purpose). The governance metadata 140 indicates a first purpose for usage of the data, and the determining the governance parameter 315 comprising determining whether the specified purpose in the request is consistent with the first purpose in the governance metadata 140 as part of an evaluation of the one or more conditions associated with the rule base 135. In an embodiment, the determining the governance parameter 315 further comprises, in response to a determination that the specified purpose is consistent with the first purpose, setting the governance parameter 315 to indicate enablement of the access request for the specified purpose, or in response to a determination that the specified purpose is inconsistent with the first purpose, setting the governance parameter 315 to indicate denial of the access request for the specified purpose. In an embodiment, when the specified purpose in the access request is consistent with the first purpose indicated in the governance metadata 140, when the transfer request is consistent with the permitted destination repositories 122-2 and/or data transfer parameters indicated in the governance metadata 140, and/or when the retention-related action is consistent with the retention schedule indicated in the governance metadata 140, the method may further comprise initiating a de-identification of the data 120 prior to initiating performance of the governance action. The governance metadata 140 further comprises a de-identification threshold associated with the data 220, such that initiating the de-identification of the data 220 comprises determining whether a risk score for the data 220 is less than the de-identification threshold associated with the data 220. The de-identification threshold may be a threshold value representing a risk level associated with retaining the data 220 at the MGP 110, moving the data 220 to a destination repository 122-2, and/or performing a retention-related action on the data 220. The at least one rule base 135 may comprise verifying whether a risk score of the data 220 is less than the de-identification threshold. The governance parameter 315 may comprise an instruction to perform de-identification on the data 330 until the risk score of the data is less than the de-identification threshold. In an embodiment, the at least one rule base 135 may comprise verifying whether a risk score of the data 220 is greater than the de-identification threshold. The governance parameter 315 may comprise an instruction to perform a de-identification method on the data 330 until the risk score of the data is greater than the de-identification threshold.

In an embodiment, when the specified purpose in the access request is consistent with the first purpose indicated in the governance metadata 140, when the transfer request is consistent with the permitted destination repositories 122-2 and/or data transfer parameters indicated in the governance metadata 140, and/or when the retention-related action is consistent with the retention schedule indicated in the governance metadata 140, and/or when a data quality of the data 220 does not meet a standard as indicated in a data quality parameter indicated in the governance metadata 140, the method may further comprise initiating a transformation the data 220 to be consistent with the data quality parameter. For example, the transformation of the data 220 may be based on various applications or purposes, such as, for example, artificial intelligence, machine learning, statistical applications, etc. In an embodiment, the governance check 303 may be the data quality governance check 303G, and the at least one rule base may comprise verifying that a quality of the data 220 is consistent with the data quality parameter.

In an embodiment, the governance check 303 performed in method 400 may be the source-related governance check 303C. In an embodiment, the trigger event comprises a transfer request for the data 220. The at least one event parameter of the transfer request comprises a requested destination repository 122-2 for the data (obtained from the transfer requested). For example, the transfer request may be a request to transfer the data 220 from a source repository 122-1 to a requested destination repository 122-2. The governance metadata 140 may be indicative of one or more permitted destination repositories 122-2 (also referred to herein as permitted repositories 122-2) for the data 220. A permitted destination repository 122-2 may refer to one or more repositories 122 (across the same or different MGPs 110) at which certain data 220 or types of data 220 may be stored (e.g., is permitted to be stored) or may not be stored (e.g., is not permitted to be stored). In this embodiment, determining the governance parameter 315 comprises determining whether the requested destination repository 122-2 is one of the one or more permitted destination repositories 122-2 for the data 220 as part of an evaluation of the one or more conditions associated with the at least one rule base 135. For example, at least one rule base 135 may indicate the permitted destination repositories 122-2 for the data 220, and the one or more conditions of the at least one rule base 135 may indicate that the data 220 may be transferred/moved to a destination repository 122-2 indicated in the transfer request when the destination repository 122-2 in the transfer request is a permitted destination repository 122-1, 122-2. Similarly, the at least one rule base 135 may indicate other types of permitted destinations for the data 220 (e.g., in which the destinations may be another MGP 110, another network site, etc.). In this case, the one or more conditions of the at least one rule base 135 may indicate that the data 220 may be transferred to a destination indicated in the transfer request when the destination is a permitted destination. In an embodiment, the governance metadata 140 may include data transfer parameters for the data 220 (e.g., indicating whether the data 220 may be moved or may have to remain in the source repository 122-1). In this embodiment, the at least one rule base 135 may include one or more conditions indicating that the data 220 may be moved to a destination indicated in the transfer request when the governance metadata 140 indicates that the data 220 may be moved. The at least one rule base 135 may indicate that the data 220 may not be moved to a destination indicated in the transfer request when the governance metadata 140 indicates that the data 220 may not be moved.

In an embodiment, the governance check 303 performed in method 400 may be the retention schedule governance check 303D. In an embodiment, the trigger event is elapsed time (e.g., a time-based event), and the governance metadata 140 comprises a retention schedule for the data. In an embodiment, determining the governance parameter 315 comprises determining a retention-related action that is consistent with the retention schedule as part of an evaluation of the one or more conditions associated with the at least one rule base 135. The at least one rule base 135 comprises one or more retention policies for the data 220. A retention policy may indicate one or more conditions, which when met, indicates that a retention-related action is to be performed on the data 220. The governance parameter 315 may be indicative of the governance action. The governance action may comprise one of maintaining existing retention of the data 220, deleting the data 220, or archiving the data 220 in accordance with the one or more retention policies. The governance action may be the same or different from the retention-related action that is determined to be consistent with the retention schedule. In an embodiment, the governance metadata 140 comprises a retention schedule of the data 220. The retention schedule indicates that the data 220 is to be archived after an applicable contract associated with the data 220 expires. The at least one rule base 135 comprises verifying whether the applicable contract associated with the data 220 has expired. The governance parameter 315 comprises an instruction to archive the data 220 in response to verifying that the applicable contract has expired.

FIG. 5 is a diagram of an embodiment of a computer system 500 in the medical governance system 100 of FIG. 1. For instance, the computer system 500 may be similar to the source 103, client 106, and MGP 110 of the medical governance system 100. In an embodiment, the governance application 111 may be embodied as a computing system 500, separate from the MGP 110. In another embodiment, the MGP 110 may be embodied as a computing system 500, in which the governance application 111 is provisioned as part of the MGP 110, which is the embodiment shown in FIG. 5 (i.e., the governance application 111 is indicated as part of the processor 505 in FIG. 5). The computer system 500 may be configured to implement and/or support the methods for performing governance checks in the MGP 110 using governance metadata 140 described herein. The computer system 500 may be implemented in a single node or the functionality of computer system 500 may be implemented in a plurality of nodes. One skilled in the art will recognize that the term computer system encompasses a broad range of devices of which computer system 500 is merely an example. The computer system 500 is included for purposes of clarity of discussion, but is in no way meant to limit the application of the present disclosure to a particular computing device embodiment or class of computing device embodiments. At least some of the features and/or methods described in the disclosure may be implemented in a device such as the computer system 500. For instance, the features and/or methods in the disclosure may be implemented using hardware, firmware, and/or software installed to run on hardware.

As shown in FIG. 5, the computer system 500 comprises one or more communications interfaces 510 (shown in FIG. 5 as “comm. interface 510”) for receiving and transmitting data, at least one processor, logic unit, or central processing unit (CPU) 505 to process the data, a memory 550 for storing the data, and a removable media drive 555. The communications interface 510 can be wired or wireless (e.g. WLAN based on IEEE 802.11 standards, and/or Wireless Wide Area Networks (WWAN) based on LTE/5G or cellular standards, and/or Wireless Personal Area Networks (WPAN), such as Bluetooth, NFC, etc., based on IEEE 802.15 standards).

The processor 505 may comprise one or more multi-core processors and be coupled to a memory 550, which may function as data stores, buffers, etc. The processor 505 may be implemented as a general processor or may be part of one or more application specific integrated circuits (ASICs) and/or digital signal processors (DSPs). The processor 505 may comprise the governance application 111, which may perform method 400 and/or the methods in outlined in FIGS. 3A-3F discussed above. As such, the inclusion of the governance application 111 and associated methods and systems provide improvements to the functionality of the computer system 500. Further, the computer system 500 effects a transformation of a particular article (e.g., the medical governance system 100) to a different state. In an alternative embodiment, governance application 111 may be implemented as instructions stored in the memory 550, which may be executed by the processor 505.

The memory 550 may comprise a cache for temporarily storing content, e.g., a random-access memory (RAM). In an embodiment, the memory 550 may include a primary memory and a secondary memory. For example, the primary memory may include one or more different types of memory devices, such as an on-chip cache, RAM (e.g., dynamic RAM (DRAM)), flash memory, read-only memory (ROM)), which may hold firmware, boot-up routines, etc. For example, the secondary memory may include one or more different types of memory devices, such as a hard drive, solid-state drive (SSD), optical drive (e.g., compact disc ROM (CD-ROM), BLU-RAY, or optical media), removable media drive 555 (e.g., universal serial bus (USB) drive or flash drive), etc. The removable media drive 555 may be a type of storage device that can be removed from the computer system 500. The removable media drive 555 may comprise removable computer-readable media. In an embodiment, the computer-readable media may include instructions to configure a processor 505 in the computer system 500 (e.g., implemented in the MGP 110) to perform the steps of method 400. The memory 550 may be configured to store the data 130, secondary use data 133, data catalog 136, governance metadata 140, and governance report 141. In some embodiments, databases and repositories (e.g., repositories 122-1, 122-2) may be held in the secondary memory of the memory 550, and records and/or other portions of the databases or repositories may be moved to the primary memory of the memory 550 for processing.

The computer system 500 may include other input/output devices not shown in FIG. 5. For example, the input/output devices may include printers, video monitors, liquid crystal displays (LCDs), touch screen displays, keyboards, keypads, switches, dials, mice, track balls, voice recognizers, card readers, paper tape readers, or other well-known input devices.

It is understood that by programming and/or loading executable instructions onto the computer system 500, at least one of the processor 505 and/or memory 550 are changed, transforming the computer system 500 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the scope of the disclosure. For example, it will be appreciated that one of ordinary skill in the art will be able to employ a number corresponding alternative and equivalent structural details, such as equivalent ways of fastening, mounting, coupling, or engaging tool components, equivalent mechanisms for producing particular actuation motions, and equivalent mechanisms for delivering electrical energy. Thus, the present disclosure is not intended to be limited to the embodiments shown herein but is to be accorded the widest scope consistent with the principles and novel features disclosed herein.

What is claimed is:

1. A processor-implemented method on a medical system governance platform (MGP), wherein the method comprises:
determining an occurrence of a trigger event, wherein the trigger event initiates a governance check to be performed on data associated with the trigger event;
obtaining, as part of the governance check, governance metadata corresponding to the data associated with the trigger event, wherein the governance metadata is associated with at least one rule base for the data associated with the trigger event, wherein the at least one rule base comprises one or more conditions for at least one of usage, transfer, storage, retention, deletion, or archival of the data;
determining, as part of the governance check, a governance parameter based on at least one of the governance metadata, at least one event parameter associated with the trigger event, and the at least one rule base, wherein the governance parameter is indicative of a governance action related to the data associated with the trigger event; and
initiating performance of the governance action based on an evaluation of the governance parameter.

2. The method of claim 1, wherein the trigger event is a request related to the data associated with the trigger event.

3. The method of claim 2, wherein obtaining the governance metadata further comprises:
determining the at least one rule base based on the at least one event parameter, wherein the at least one event parameter is based on at least one of: a source associated with the request, a type of the request, a destination associated with the request, source data associated with the source of the request, or requested data specified as part of the request.

4. The method of claim 1, wherein the at least one rule base is determined based on at least one of a contractual provision, a government regulation, or an organizational policy applicable to at least one of a usage of the data, a transfer of the data, a storage of the data, a retention of the data, a deletion of the data, or an archival of the data.

5. The method of claim 4, wherein obtaining the governance metadata comprises applying natural language processing (NLP) to one or more documents that include one or more of the contractual provision, the government regulation, or the organizational policy to obtain the governance metadata.

6. The method of claim 1, wherein the trigger event comprises a request to store source data at the MGP, wherein the governance metadata comprises a contract identifier, and wherein the governance parameter is indicative of the governance action comprising one of storing the source data or rejecting the request.

7. The method of claim 1, wherein:
the trigger event comprises an access request to the data for a specified purpose, and
the governance metadata indicates a first purpose for usage of the data, and,
wherein determining the governance parameter comprises:
determining whether the specified purpose is consistent with the first purpose as part of a second evaluation of the one or more conditions associated with the at least one rule base.

8. The method of claim 7, wherein determining the governance parameter further comprises:
in response to a first determination that the specified purpose is consistent with the first purpose, setting the governance parameter to indicate enablement of the access request for the specified purpose; or
in response to a second determination that the specified purpose is inconsistent with the first purpose, setting the governance parameter to indicate denial of the access request for the specified purpose.

9. The method of claim 7, wherein, in response to a determination that the specified purpose is consistent with the first purpose, initiating a de-identification of the data prior to initiating performance of the governance action.

10. The method of claim 9, wherein the governance metadata further comprises a de-identification threshold associated with the data, and wherein initiating the de-identification of the data comprises determining whether a risk score for the data is less than the de-identification threshold associated with the data.

11. The method of claim 7, wherein the governance metadata further comprises a data quality parameter associated with the data, wherein, in response to a determination that the specified purpose is consistent with the first purpose, initiating a transformation of the data to be consistent with the data quality parameter prior to initiating performance of the governance action.

12. The method of claim 1, wherein:
the trigger event comprises a transfer request for the data, and
the governance metadata is indicative of one or more permitted repositories for the data,
the at least one event parameter of the transfer request comprises a requested destination repository for the data, and,
wherein determining the governance parameter comprises:
determining whether the requested destination repository in the transfer request is one of the one or more permitted repositories for the data as part of a second evaluation of the one or more conditions associated with the at least one rule base.

13. The method of claim 1, wherein:
the trigger event is elapsed time, and
the governance metadata comprises a retention schedule for the data, and,
wherein determining the governance parameter comprises:
determining a retention-related action that is consistent with the retention schedule as part of a second evaluation of the one or more conditions associated with the at least one rule base,
wherein the at least one rule base comprises one or more retention polices for the data, and
wherein the governance parameter is indicative of the governance action, and wherein the governance action comprises one of maintaining existing retention of the data, deleting the data, or archiving the data in accordance with the one or more retention policies.

14. A medical system governance platform (MGP), comprising:
a memory configured to store instructions; and
a processor coupled to the memory and configured to execute the instructions, which cause the processor to be configured to:
determine an occurrence of a trigger event, wherein the trigger event initiates a governance check to be performed on data associated with the trigger event;
obtain, as part of the governance check, governance metadata corresponding to the data associated with the trigger event, wherein the governance metadata is associated with at least one rule base for the data associated with the trigger event, wherein the at least one rule base comprises one or more conditions for at least one of usage, transfer, storage, retention, deletion, or archival of the data;
determine, as part of the governance check, a governance parameter based on at least one of the governance metadata, at least one event parameter associated with the trigger event, and the at least one rule base, wherein the governance parameter is indicative of a governance action related to the data associated with the trigger event; and
initiate performance of a governance action based on an evaluation of the governance parameter.

15. The MGP of claim 14, wherein the trigger event is a request related to the data associated with the trigger event, wherein the instructions further cause the processor to be configured to:
determine the at least one rule base based on the at least one event parameter, wherein the at least one event parameter is based on at least one of: a source of the request, a type of the request, a destination associated with the request, source data associated with the source of the request, or requested data specified as part of the request.

16. The MGP of claim 14, wherein the at least one rule base is determined based on at least one of a contractual provision, a government regulation, or an organizational policy applicable to at least one of a usage of the data, a transfer of the data, a storage of the data, a retention of the data, a deletion of the data, or an archival of the data, and wherein the instructions further cause the processor to be configured to apply natural language processing (NLP) to documents that include one or more of the contractual provision, the government regulation, or the organizational policy to obtain the governance metadata.

17. The MGP of claim 14, wherein the trigger event comprises a request to store source data at the MGP, wherein the governance metadata comprises a contract identifier, and wherein the governance parameter is indicative of the governance action comprising one of storing the source data or rejecting the request.

18. The MGP of claim 14, wherein:
the trigger event comprises an access request to the data for a specified purpose, and
the governance metadata indicates a first purpose for usage of the data, and,
wherein the instructions further cause the processor to be configured to:
determine whether the specified purpose is consistent with the first purpose as part of an evaluation of the one or more conditions associated with the rule base.

19. A non-transitory computer readable medium comprising instructions to configure a processor in a medical system governance platform (MGP) to:
determine an occurrence of a trigger event, wherein the trigger event initiates a governance check to be performed on data associated with the trigger event;
obtain, as part of the governance check, governance metadata corresponding to the data associated with the trigger event, wherein the governance metadata is associated with at least one rule base for the data associated with the trigger event, wherein the at least one rule base comprises one or more conditions for at least one of usage, transfer, storage, retention, deletion, or archival of the data;
determine, as part of the governance check, a governance parameter based on at least one of the governance metadata, at least one event parameter associated with the trigger event, and the at least one rule base, wherein the governance parameter is indicative of a governance action related to the data associated with the trigger event; and
initiate performance of a governance action based on an evaluation of the governance parameter.

20. The non-transitory computer readable medium of claim 19, wherein the trigger event is a request related to the data associated with the trigger event, wherein the instructions further cause the processor to be configured to:
determine the at least one rule base based on the at least one event parameter, wherein the at least one event parameter is based on at least one of: a source of the request, a type of the request, a destination associated with the request, source data associated with the source of the request, or requested data specified as part of the request.
